(19) United States
(12) Patent Application Publication
(10) Pub. No.: US 2020/0270451 A1
(43) Pub. Date: Aug. 27, 2020

(54) FLAME-RETARDANT POLYCARBONATE-ACRYLATE RUBBER COMPOSITION WITH LOW BISPHENOL A CONTENT

(71) Applicant: Covestro Deutschland AG, Leverkusen (DE)

(72) Inventors: Thomas Eckel, Dormagen (DE); Sven Hobeika, Solingen (DE); Ralf Hufen, Duisburg (DE); Andreas Seidel, Dormagen (DE); Burkhard Thuermer, Bornheim (DE)

(21) Appl. No.: 16/755,753

(22) PCT Filed: Jun. 22, 2018
(86) PCT No.: PCT/EP2018/066718

§ 371 Date: Apr. 13, 2020

(30) Foreign Application Priority Data
Oct. 16, 2017 (EP) 17196679.9

(51) Int. Cl. C08L 69/00

(52) U.S. Cl. CPC C08L 69/00; C08L 2205/025; C08L 2205/035

(57) ABSTRACT

The invention relates to a composition for production of a thermoplastic moulding compound, wherein the composition comprises or consists of at least the following constituents:
A) 50.0% to 95.0% by weight of at least one polymer selected from the group consisting of aromatic polycarbonate, aromatic polyestercarbonate and aromatic polyester,
B) 1.0% to 35.0% by weight of at least one polymer free of epoxy groups, consisting of
   B1) a rubber-modified graft polymer having an elastomeric acrylate rubber graft base,
   B2) optionally a rubber-modified graft polymer based on vinylaromatics, ring-substituted vinylaromatics and/or (C1-C8)-alkyl methacrylates and having a different graft base from component B1), and
   B3) optionally a rubber-free vinyl (co)polymer,
C) 0.1% to 10.0% by weight of a polymer containing structural elements that derive from styrene and an epoxy-containing vinyl monomer,
D) 1.0% to 20.0% by weight of phosphorus-containing flame retardant, and
E) 0.1% to 20.0% by weight of additives,
   where component C has a weight ratio of structural elements that derive from styrene to those that derive from epoxy-containing vinyl monomers of 100:1 to 1:1. The invention further relates to the use of the composition and to a process for producing such a moulding compound and to the moulding compound itself. The invention additionally relates to a moulded article formed from the aforementioned moulding compound.

The invention relates to a composition for production of a thermoplastic moulding compound comprising an aromatic polycarbonate, aromatic polyestercarbonate and/or an aromatic polyester, to the use of the composition and to a process for producing such a moulding compound, and the moulding compound itself. The invention additionally relates to a moulded article formed from the aforementioned moulding compound.

Polycarbonate compositions have long been known. These materials are used to produce moulded articles for a very wide variety of applications, for example in the automobile sector, for rail vehicles, for the construction sector, in the electrical/electronics sector and in domestic appliances. The quantity and nature of the constituents in the formulation can be varied to achieve a wide range of modification of the compositions, and thus also of the resultant moulded articles, so that the thermal, rheological and mechanical properties of these are appropriate to the requirements of each application.

The moulded articles are frequently produced by injection moulding methods, and in such cases it is advantageous when the thermoplastic moulding compounds used for this purpose have good melt flowability in order to enable processing to form thin-walled components at low melting temperature.

As well as polycarbonate, further constituents used are frequently other polymer components such as vinyl (co)polymers. However, these have only partial compatibility with polycarbonate. For this reason, phase compatibilizers are frequently used, for example in the form of copolymers having specific functional groups, in order to improve the mechanical properties of moulded articles produced from the thermoplastic moulding compounds. However, phase compatibilizers of this kind can alter surface properties and lead to a low level of gloss, which is undesirable in some cases.

EP 1 854 842 B1 discloses styrene resin compositions comprising polycarbonate, a styrene-based resin, for example ABS, a modified styrene-based polymer having vinyl-based monomer units. The styrene-based polymer has been provided with a functional group selected from carboxyl groups, hydroxyl groups, epoxy groups, amino groups and oxazoline groups. The styrene resin and the polycarbonate have a dispersed structure with a phase separation of 0.001 to 1 pm. The compositions are suitable for processing by injection moulding, have excellent mechanical properties, flowability, chemical resistance and galvanizability, and can easily be rendered flame-retardant.

EP 1 069 156 B1 discloses flame-retardant thermoplastic compositions comprising polycarbonate, styrene graft polymer, styrene copolymer, SAN-grafted polycarbonate or polycarbonate-grafted SAN and phosphoric esters. The compositions have improved flame retardancy and improved mechanical properties, and are suitable for housings for electrical or electronic appliances.

JP 2011153294 A describes compositions comprising styrene resin, polycarbonate, polycarbonate-graft-SAN copolymer and fillers, in which styrene resin and polycarbonate have a dispersed structure with a phase separation of 0.001 to 1 pm.

CN 104004333 A, CN 104004331 A and CN 102719077 A disclose PC-ABS compositions comprising a polycarbonate, an acrylonitrile-butadiene-styrene polymer, an impact modifier and a compatibilizer.

CN 102516734 A discloses flame-retardant PC+ABS compositions having improved surface impact resistance, comprising polycarbonate, acrylonitrile-butadiene-styrene polymer, impact modifier, a compatibilizer and a phosphoric ester as flame retardant.

JP 3603839 B2 and JP 3969006 B2 disclose PC+ABS compositions having good processing characteristics in injection moulding, and good heat and impact resistance. The compositions comprise polycarbonate, ABS resin and a graft polymer grafted onto polycarbonate with polystyrene segments.

The desire for ever thinner applications, specifically in the fields of IT, electrics and electronics, leads to more significant shear stress in processing in the case of the flame-retardant PC/ABS blends that have been reinforced with fillers. This can result in worsened mechanical properties, detriments to visual appearance and reduced flame retardancy. In addition, under these processing conditions, there can be increased degradation phenomena in the polycarbonate, which is manifested in an elevated content of phenols, especially of bisphenol A, in the product.

The problem addressed by the invention was thus that of providing a flame-retardant, polycarbonate-containing composition for production of a thermoplastic moulding compound which, on processing, exhibits improved mechanical properties, improved flame retardancy, especially good melt stability after thermal storage and hydrolytic stress, and additionally, after processing, has a lower content of phenols formed as a result of polycarbonate degradation phenomena, especially of bisphenol A. After processing, improved chemical stability to various media is preferably additionally to be achieved. Preferably, the flow characteristics of the moulding compounds are not to be significantly worsened.

The problem was solved by a composition for production of a thermoplastic moulding compound, wherein the composition comprises or consists of at least the following constituents:
A) 50.0% to 95.0% by weight of at least one polymer selected from the group consisting of aromatic polycarbonate, aromatic polyestercarbonate and aromatic polyester,
B) 1.0% to 35.0% by weight of at least one polymer free of epoxy groups, consisting of
   B1) a rubber-modified graft polymer having an elastomeric acrylate rubber graft base,
   B2) optionally a rubber-modified graft polymer based on vinylaromatics, ring-substituted vinylaromatics and/or (C1-C8)-alkyl methacrylates and having a different graft base from component B1), and
   B3) optionally a rubber-free vinyl (co)polymer,
C) 0.1% to 10.0% by weight of a polymer containing structural elements that derive from styrene and an epoxy-containing vinyl monomer,
D) 1.0% to 20.0% by weight of phosphorus-containing flame retardant, and
E) 0.1% to 20.0% by weight of additives,
   where component C has a weight ratio of structural elements that derive from styrene to those that derive from epoxy-containing vinyl monomers of 100:1 to 1:1.

It has been found that, surprisingly, moulding compounds composed of such compositions have good mechanical properties, for example fracture characteristics and modulus of elasticity. They additionally have improved flame retardancy with reduced afterflame times and good processibility, and, after processing under shear, have a lower content of phenols, especially of bisphenol A (BPA), formed as a result of polycarbonate degradation phenomena during processing to give the moulding compound. When the content of component C chosen is too high, this can lead to an unwanted deterioration in the flow characteristics, which can have an adverse effect on the suitability of the moulding compounds for injection moulding applications.

In a preferred embodiment of the composition according to the invention, it comprises or consists of the following components:
A) 51.0% to 85.0% by weight, especially 52.0% to 75.0% by weight, most preferably 55.0% to 72.0% by weight, of aromatic polycarbonate and/or aromatic polyestercarbonate,
B) 2.0% to 25.0% by weight, especially 3.0% to 15.0% by weight, most preferably 5.0% to 14.0% by weight, of polymer free of epoxy groups, consisting of 20% to 80% by weight, especially 30% to 50% by weight, of the emulsion graft polymer B1) prepared by an emulsion polymerization process from
   B1.1) 10% to 70% by weight, preferably 20% to 60% by weight, based on component B1, of a mixture of
      B1.1.1) 70% to 80% by weight, based on B1.1, of at least one monomer selected from the group of the vinylaromatics, ring-substituted vinylaromatics and (C1-C8)-alkyl methacrylates and
      B1.1.2) 20% to 30% by weight, based on B1.1, of at least one monomer selected from the group of the vinyl cyanides, (C1-C8)-alkyl (meth)acrylates and derivatives of unsaturated carboxylic acids, onto
   B1.2) 90% to 30% by weight, based on component B1, of at least one elastomeric acrylate rubber graft base selected from polymers of alkyl acrylates, optionally with up to 40% by weight, based on B1.2, of other polymerizable, ethylenically unsaturated monomers, where the acrylic esters are preferably selected from C₁ to C₈-alkyl esters, especially methyl, ethyl, butyl, n-octyl and 2-ethylhexyl esters, haloalkyl esters, especially halo-C₁-C₈-alkyl esters, and mixtures of these, and
20% to 80% by weight, especially 50% to 70% by weight, of the bulk, solution or suspension graft polymer B2) prepared by a bulk, solution or suspension polymerization process from
   B2.1) 80% to 93% by weight, especially 85% to 92% by weight, based on component B2, of a mixture of
      B2.1.1) 70% to 80% by weight, based on the mixture B2.1, of at least one monomer selected from the group of the vinylaromatics, ring-substituted vinylaromatics and (C1-C8)-alkyl methacrylates and
      B2.1.2) 20% to 30% by weight, based on the mixture B2.1, of at least one monomer selected from the group of the vinyl cyanides, (C1-C8)-alkyl (meth)acrylates and derivatives of unsaturated carboxylic acids, onto
   B2.2) 20% to 7% by weight, especially 15% to 8% by weight, based on component B2, of at least one graft base,
C) 0.3% to 8.0% by weight, especially 0.5% to 6.0% by weight, most preferably 3.0% to 6.0% by weight, of the epoxy-vinyl polymer comprising or consisting of structural units that derive from styrene and from a vinyl monomer containing epoxy groups,
D) 2.0% to 18.0% by weight, especially 3.0% to 16.0% by weight, most preferably 5.0% to 15.0% by weight, of phosphorus-containing flame retardant, and
E) 0.2% to 18.0% by weight, especially 0.3% to 16.0% by weight, most preferably 0.4% to 10.0% by weight, of additives,
where the amounts of components A to E and the composition of components B1, B2 and B3 are independent of one another.

The preferred moulding compounds according to the invention feature an optimized combination of mechanical properties, good flow characteristics, flame retardancy, particularly at relatively low wall thicknesses, and thermal stability.

Preference is further given to a composition according to the invention that comprises or consists of the following components:
A) 51.0% to 85.0% by weight, especially 52.0% to 75.0% by weight, of aromatic polycarbonate and/or aromatic polyestercarbonate,
B) 2.0% to 25.0% by weight, especially 3.0% to 15.0% by weight, of polymer free of epoxy groups, consisting of
40% to 98% by weight, especially 45% to 95% by weight, of the emulsion graft polymer B1) prepared by an emulsion polymerization process from
   B1.1) 10% to 70% by weight, preferably 20% to 60% by weight, based on component B1, of a mixture of
      B1.1.1) 70% to 80% by weight, based on B1.1, of at least one monomer selected from the group of the vinylaromatics, ring-substituted vinylaromatics and (C1-C8)-alkyl methacrylates and
      B1.1.2) 20% to 30% by weight, based on B1.1, of at least one monomer selected from the group of the vinyl cyanides, (C1-C8)-alkyl (meth)acrylates and derivatives of unsaturated carboxylic acids, onto
   B1.2) 90% to 30% by weight, based on component B1, of at least one elastomeric acrylate rubber graft base selected from polymers of alkyl acrylates, optionally with up to 40% by weight, based on B1.2, of other polymerizable, ethylenically unsaturated monomers, where the acrylic esters are preferably selected from C₁ to C8-alkyl esters, especially methyl, ethyl, butyl, n-octyl and 2-ethylhexyl esters, haloalkyl esters, especially halo-C₁-C₈-alkyl esters, and mixtures of these, and
2% to 60% by weight, especially 5% to 55% by weight, of the rubber-free vinyl (co)polymer B3 prepared from
   B3.1 65% to 85% by weight, especially 70% to 80% by weight, based on the (co)polymer B3, of at least one monomer selected from the group of the vinylaromatics, ring-substituted vinylaromatics and (C1-C8)-alkyl (meth)acrylates and
   B3.2 15% to 35% by weight, especially 20% to 30% by weight, based on the (co)polymer B3, of at least one monomer selected from the group of the vinyl cyanides, (C1-C8)-alkyl (meth)acrylates, unsaturated carboxylic acids and derivatives of unsaturated carboxylic acids,
C) 0.3% to 8.0% by weight, especially 0.5% to 6.0% by weight, of the epoxy-vinyl polymer comprising or consisting of structural units that derive from styrene and from a vinyl monomer containing epoxy groups,
D) 2.0% to 18.0% by weight, especially 3.0% to 16.0% by weight, of phosphorus-containing flame retardant, and
E) 0.2% to 18.0% by weight, especially 0.3% to 16.0% by weight, of additives,
where the amounts of components A to E and the composition of components B1, B2 and B3 are independent of one another.

Preference is further given to a composition according to the invention that comprises or consists of the following components:
A) 58.0% to 85.0% by weight of aromatic polycarbonate and/or aromatic polyestercarbonate,
B) 5.0% to 20.0% by weight of polymer free of epoxy groups, consisting of 40% to 98% by weight, especially 45% to 95% by weight, of the emulsion graft polymer B1) prepared by an emulsion polymerization process from
   B1.1) 10% to 70% by weight, preferably 20% to 60% by weight, based on component B1, of a mixture of
      B1.1.1) 70% to 80% by weight, based on B1.1, of at least one monomer selected from the group of the vinylaromatics, ring-substituted vinylaromatics and (C1-C8)-alkyl methacrylates and
      B1.1.2) 20% to 30% by weight, based on B1.1, of at least one monomer selected from the group of the vinyl cyanides, (C1-C8)-alkyl (meth)acrylates and derivatives of unsaturated carboxylic acids, onto
   B1.2) 90% to 30% by weight, based on component B1, of at least one elastomeric acrylate rubber graft base selected from polymers of alkyl acrylates, optionally with up to 40% by weight, based on B1.2, of other polymerizable, ethylenically unsaturated monomers, where the acrylic esters are preferably selected from C₁ to C₈-alkyl esters, especially methyl, ethyl, butyl, n-octyl and 2-ethylhexyl esters, haloalkyl esters, especially halo-C₁-C₈-alkyl esters, and mixtures of these, and
2% to 60% by weight, especially 5% to 55% by weight, of the rubber-free vinyl (co)polymer B3 prepared from
   B3.1 65% to 85% by weight, especially 70% to 80% by weight, based on the (co)polymer B3, of at least one monomer selected from the group of the vinylaromatics, ring-substituted vinylaromatics and (C1-C8)-alkyl (meth)acrylates and
   B3.2 15% to 35% by weight, especially 20% to 30% by weight, based on the (co)polymer B3, of at least one monomer selected from the group of the vinyl cyanides, (C1-C8)-alkyl (meth)acrylates, unsaturated carboxylic acids and derivatives of unsaturated carboxylic acids,
C) 3.0% to 6.0% by weight of the epoxy-vinyl polymer comprising or consisting of structural units that derive from styrene and from a vinyl monomer containing epoxy groups,
D) 2.0% to 18.0% by weight of phosphorus-containing flame retardant, and
E) 0.4% to 10.0% by weight of additives,
where the amounts of components A to E and the composition of components B1 and B3 are independent of one another.

The preferred moulding compounds according to the invention feature an optimized combination of mechanical properties, flame retardancy and thermal stability under defined storage conditions (temperature and air humidity).

### Component A

Polycarbonates in the context of the present invention are either homopolycarbonates or copolycarbonates and/or polyestercarbonates; the polycarbonates may be linear or branched in a known manner According to the invention, it is also possible to use mixtures of polycarbonates.

The thermoplastic polycarbonates, including the thermoplastic aromatic polyestercarbonates, have average molecular weights M_{w} determined by GPC (gel permeation chromatography in methylene chloride with polycarbonate based on bisphenol A as standard) of 20 000 g/mol to 50 000 g/mol, preferably of 23 000 g/mol to 40 000 g/mol, especially of 26 000 g/mol to 35 000 g/mol.

A portion, up to 80 mol %, preferably of 20 mol % to 50 mol %, of the carbonate groups in the polycarbonates used in accordance with the invention may have been replaced by aromatic dicarboxylic ester groups. Polycarbonates of this kind that incorporate both acid radicals from the carbonic acid and acid radicals from aromatic dicarboxylic acids into the molecular chain are referred to as aromatic polyestercarbonates. In the context of the present invention, they are covered by the umbrella term of thermoplastic aromatic polycarbonates.

The polycarbonates are prepared in a known manner from diphenols, carbonic acid derivatives, optionally chain terminators and optionally branching agents, and the polyestercarbonates are prepared by replacing a portion of the carbonic acid derivatives with aromatic dicarboxylic acids or derivatives of the dicarboxylic acids, to a degree according to the extent to which carbonate structural units in the aromatic polycarbonates are to be replaced by aromatic dicarboxylic ester structural units.

Dihydroxyaryl compounds suitable for the preparation of polycarbonates are those of the formula (I)

HO—Z—OH (I)

in which

Z is an aromatic radical which has 6 to 30 carbon atoms and may contain one or more aromatic rings, may be substituted and may contain aliphatic or cycloaliphatic radicals or alkylaryls or heteroatoms as bridging elements.

Z in formula (I) is preferably a radical of the formula (II)

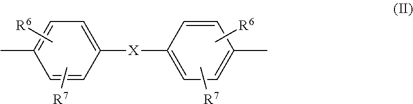

in which

R⁶ and R⁷ are independently H, C₁- to C₁₈-alkoxy, C₁- to C₁₈-alkoxy, halogen such as Cl or Br or in each case optionally substituted aryl or aralkyl, preferably H or C₁- to C₁₂-alkyl, more preferably H or C₁- to C₈-alkyl and most preferably H or methyl, and

X is a single bond, —SO₂—, —CO—, —O—, —S—, C₁- to C₆-alkylene, C₂- to C₅-alkylidene or C₅- to C₆-cycloalkylidene which may be substituted by C₁- to C₆-alkyl, preferably methyl or ethyl, or else is C₆- to C₁₂-arylene, which may optionally be fused to other aromatic rings containing heteroatoms.

Preferably, X is a single bond, C₁- to C₅-alkylene, C₂- to C₅-alkylidene, C₅- to C₆-cycloalkylidene, —O—, —SO—, —CO—, —S—, —SO₂—

or a radical of the formula (IIa)

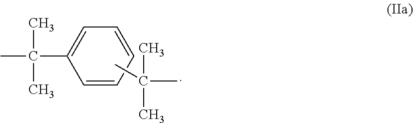

Examples of dihydroxyaryl compounds (diphenols) are: dihydroxybenzenes, dihydroxydiphenyls, bis(hydroxyphenyl)alkanes, bis(hydroxyphenyl)cycloalkanes, bis(hydroxyphenyl)aryls, bis(hydroxyphenyl) ethers, bis(hydroxyphenyl) ketones, bis(hydroxyphenyl) sulfides, bis(hydroxyphenyl) sulfones, bis(hydroxyphenyl) sulfoxides, 1,1′-bis(hydroxyphenyl)diisopropylbenzenes and the ring-alkylated and ring-halogenated compounds thereof.

Examples of diphenols suitable for the preparation of the polycarbonates to be used in accordance with the invention are hydroquinone, resorcinol, dihydroxydiphenyl, bis(hydroxyphenyl)alkanes, bis(hydroxyphenyl)cycloalkanes, bis(hydroxyphenyl) sulfides, bis(hydroxyphenyl) ethers, bis(hydroxyphenyl) ketones, bis(hydroxyphenyl) sulfones, bis(hydroxyphenyl) sulfoxides, α,α′-bis(hydroxyphenyl)diisopropylbenzenes and alkylated, ring-alkylated and ring-halogenated compounds thereof.

Preferred diphenols are 4,4′-dihydroxydiphenyl, 2,2-bis(4-hydroxyphenyl)-1-phenylpropane, 1,1-bis(4-hydroxyphenyl)phenylethane, 2,2-bis(4-hydroxyphenyl)propane, 2,4-bis(4-hydroxyphenyl)-2-methylbutane, 1,3-bis[2-(4-hydroxyphenyl)-2-propyl]benzene (bisphenol M), 2,2-bis(3-methyl-4-hydroxyphenyl)propane, bis(3,5-dimethyl-4-hydroxyphenyl)methane, 2,2-bis(3,5-dimethyl-4-hydroxyphenyl)propane, bis(3,5-dimethyl-4-hydroxyphenyl) sulfone, 2,4-bis(3,5-dimethyl-4-hydroxyphenyl)-2-methylbutane, 1,3-bis[2-(3,5-dimethyl-4-hydroxyphenyl)-2-propyl]benzene and 1,1-bis(4-hydroxyphenyl)-3,3,5-trimethylcyclohexane (bisphenol TMC).

Particularly preferred diphenols are 4,4′-dihydroxydiphenyl, 1,1-bis(4-hydroxyphenyl)phenylethane, 2,2-bis(4-hydroxyphenyl)propane (bisphenol A), 2,2-bis(3,5-dimethyl-4-hydroxyphenyl)propane, 1,1-bis(4-hydroxyphenyl)cyclohexane and 1,1-bis(4-hydroxyphenyl)-3,3,5-trimethylcyclohexane (bisphenol TMC). 2,2-Bis(4-hydroxyphenyl)propane (bisphenol A) is especially preferred.

These and further suitable diphenols are described, for example, in U.S. Pat. Nos. 2,999,835 A, 3,148,172 A, 2,991,273 A, 3,271,367 A, 4,982,014 A and 2,999,846 A, in German published specifications 1 570 703 A, 2 063 050 A, 2 036 052 A, 2 211 956 A and 3 832 396 A, in

French patent 1 561 518 A1, in the monograph “H. Schnell, Chemistry and Physics of Polycarbonates, Interscience Publishers, New York 1964, p. 28 ff.; p.102 ff.”, and in “D. G. Legrand, J. T. Bendler, Handbook of Polycarbonate Science and Technology, Marcel Dekker New York 2000, p. 72ff.”.

In the case of the homopolycarbonates, only one diphenol is used; in the case of copolycarbonates, two or more diphenols are used. The diphenols used, like all the other chemicals and auxiliaries added to the synthesis, may be contaminated with the impurities originating from their own synthesis, handling and storage. However, it is desirable to work with the purest possible raw materials.

The monofunctional chain terminators needed to regulate the molecular weight, such as phenols or alkylphenols, especially phenol, p-tert-butylphenol, isooctylphenol, cumylphenol, the chlorocarbonic esters thereof or acid chlorides of monocarboxylic acids or mixtures of these chain terminators, are either supplied to the reaction together with the bisphenoxide(s) or else added to the synthesis at any time, provided that phosgene or chlorocarbonic acid end groups are still present in the reaction mixture, or, in the case of the acid chlorides and chlorocarbonic esters as chain terminators, provided that sufficient phenolic end groups of the polymer being formed are available. However, it is preferable when the chain terminator(s) is/are added after the phosgenation at a location or at a juncture at which phosgene is no longer present but the catalyst has not yet been metered into the system or when they are metered into the system before the catalyst or together or in parallel with the catalyst.

Any branching agents or branching agent mixtures to be used are added to the synthesis in the same way, but typically before the chain terminators. Typically, trisphenols, quaterphenols or acid chlorides of tri- or tetracarboxylic acids are used, or else mixtures of the polyphenols or the acid chlorides.

Some of the compounds having three or more than three phenolic hydroxyl groups that are usable as branching agents are, for example, phloroglucinol, 4,6-dimethyl-2,4,6-tri-(4-hydroxyphenyl)hept-2-ene, 4,6-dimethyl-2,4,6-tri(4-hydroxyphenyl)heptane, 1,3,5-tris(4-hydroxyphenyl)benzene, 1,1,1-tri(4-hydroxyphenyl)ethane, tris(4-hydroxyphenyl)phenylmethane, 2,2-bis[4,4-bis(4-hydroxyphenyl)cyclohexyl]propane, 2,4-bis(4-hydroxyphenylisopropyl)phenol, tetra(4-hydroxyphenyl)methane.

Some of the other trifunctional compounds are 2,4-dihydroxybenzoic acid, trimesic acid, cyanuric chloride and 3,3-bis(3-methyl-4-hydroxyphenyl)-2-oxo-2,3-dihydroindole.

Preferred branching agents are 3,3-bis(3-methyl-4-hydroxyphenyl)-2-oxo-2,3-dihydroindole and 1,1,1-tri(4-hydroxyphenyl)ethane.

The amount of any branching agents to be used is 0.05 mol % to 2 mol %, again based on moles of diphenols used in each case.

The branching agents may either be included together with the diphenols and the chain terminators in the initially charged aqueous alkaline phase or be added dissolved in an organic solvent before the phosgenation.

All these measures for preparation of the polycarbonates are familiar to those skilled in the art.

Aromatic dicarboxylic acids suitable for the preparation of the polyestercarbonates are, for example, orthophthalic acid, terephthalic acid, isophthalic acid, tert-butylisophthalic acid, 3,3′-diphenyldicarboxylic acid, 4,4′-diphenyldicarboxylic acid, 4,4-benzophenonedicarboxylic acid, 3,4′-benzophenonedicarboxylic acid, 4,4′-diphenyl ether dicarboxylic acid, 4,4′-diphenyl sulfone dicarboxylic acid, 2,2-bis(4-carboxyphenyl)propane, trimethyl-3-phenylindane-4,5′-dicarboxylic acid.

Among the aromatic dicarboxylic acids, particular preference is given to using terephthalic acid and/or isophthalic acid.

Derivatives of the dicarboxylic acids are the dicarbonyl dihalides and the dialkyl dicarboxylates, especially the dicarbonyl dichlorides and the dimethyl dicarboxylates.

The carbonate groups are replaced essentially stoichiometrically and also quantitatively by the aromatic dicarboxylic ester groups, and so the molar ratio of the coreactants is also reflected in the finished polyestercarbonate. The aromatic dicarboxylic ester groups can be incorporated either randomly or in blocks.

Preferred modes of production of the polycarbonates to be used according to the invention, including the polyestercarbonates, are the known interfacial process and the known melt transesterification process (cf. e.g. WO 2004/063249 A1, WO 2001/05866 A1, WO 2000/105867, U.S. Pat. Nos. 5,340,905 A, 5,097,002 A, 5,717,057 A).

In the first case the acid derivatives used are preferably phosgene and optionally dicarbonyl dichlorides; in the latter case preferably diphenyl carbonate and optionally dicarboxylic diesters. Catalysts, solvents, workup, reaction conditions etc. for polycarbonate preparation or polyestercarbonate preparation are sufficiently well-described and known in both cases.

The polycarbonates suitable in accordance with the invention as component A have an OH end group concentration of 50 to 2000 ppm, preferably 80 to 1000 ppm, more preferably 100 to 700 ppm.

The OH end group concentration is determined by photometric means according to Horbach, A.; Veiel, U.; Wunderlich, H., Makromolekulare Chemie 1965, volume 88, p. 215-231.

Preferably, component A has phenolic OH groups and the stoichiometric ratio of the epoxy groups of component C) to the phenolic OH groups of component A is at least 1:1, especially at least 1.1:1, preferably at least 1.2:1, where component A preferably has a proportion by weight of phenolic OH groups of 50 to 2000 ppm, preferably 80 to 1000 ppm, more preferably 100 to 700 ppm.

Useful polyesters in a preferred embodiment are aromatic, and they are further preferably polyalkylene terephthalates.

In a particularly preferred embodiment, these are reaction products of aromatic dicarboxylic acids or reactive derivatives thereof, such as dimethyl esters or anhydrides, and aliphatic, cycloaliphatic or araliphatic diols and also mixtures of these reaction products.

Particularly preferred aromatic polyalkylene terephthalates contain at least 80% by weight, preferably at least 90% by weight, based on the dicarboxylic acid component, of terephthalic acid radicals and at least 80% by weight, preferably at least 90% by weight, based on the diol component, of ethylene glycol and/or butane-1,4-diol radicals.

The preferred aromatic polyalkylene terephthalates may contain, as well as terephthalic acid radicals, up to 20 mol %, preferably up to 10 mol %, of radicals of other aromatic or cycloaliphatic dicarboxylic acids having 8 to 14 carbon atoms or of aliphatic dicarboxylic acids having 4 to 12 carbon atoms, for example radicals of phthalic acid, isophthalic acid, naphthalene-2,6-dicarboxylic acid, 4,4′-diphenyldicarboxylic acid, succinic acid, adipic acid, sebacic acid, azelaic acid, cyclohexanediacetic acid.

The preferred aromatic polyalkylene terephthalates may contain not only ethylene glycol and/or butane-1,4-diol radicals but also up to 20 mol %, preferably up to 10 mol %, of other aliphatic diols having 3 to 12 carbon atoms or cycloaliphatic diols having 6 to 21 carbon atoms, for example radicals of propane-1,3-diol, 2-ethylpropane-1,3-diol, neopentyl glycol, pentane-1,5-diol, hexane-1,6-diol, cyclohexane-1,4-dimethanol, 3-ethylpentane-2,4-diol, 2-methylpentane-2,4-diol, 2,2,4-trimethylpentane-1,3-diol, 2-ethylhexane-1,3-diol, 2,2-diethylpropane-1,3-diol, hexane-2,5-diol, 1,4-di(β-hydroxyethoxylbenzene, 2,2-bis(4-hydroxycyclohexyl)propane, 2,4-dihydroxy-1,1,3,3-tetramethylcyclobutane, 2,2-bis(4-(β-hydroxyethoxyphenyl)propane and 2,2-bis(4-hydroxypropoxyphenyl)propane (DE-A 2 407674, 2 407 776, 2 715 932).

The aromatic polyalkylene terephthalates may be branched through incorporation of relatively small amounts of tri- or tetrahydric alcohols or tri- or tetrabasic carboxylic acids, for example according to DE-A 1 900 270 and U.S. Pat. No. 3,692,744. Examples of preferred branching agents are trimesic acid, trimellitic acid, trimethylolethane and trimethylolpropane, and pentaerythritol.

Particular preference is given to aromatic polyalkylene terephthalates which have been prepared solely from terephthalic acid and the reactive derivatives thereof (e.g. the dialkyl esters thereof) and ethylene glycol and/or butane-1,4-diol, and to mixtures of these polyalkylene terephthalates.

Preferred mixtures of aromatic polyalkylene terephthalates contain 1% to 50% by weight, preferably 1% to 30% by weight, of polyethylene terephthalate and 50% to 99% by weight, preferably 70% to 99% by weight, of polybutylene terephthalate.

The preferably used aromatic polyalkylene terephthalates have a viscosity number of 0.4 to 1.5 dl/g, preferably 0.5 to 1.2 dl/g, measured in phenol/o-dichlorobenzene (1:1 parts by weight) in a concentration of 0.05 g/ml according to ISO 307 at 25° C. in an Ubbelohde viscometer.

The aromatic polyalkylene terephthalates can be prepared by known methods (see, for example, Kunststoff-Handbuch [Plastics Handbook], volume VIII, p. 695 et seq., Carl-Hanser-Verlag, Munich 1973).

A most preferred component A used is aromatic polycarbonate based on bisphenol A.

### Component B

Component B consists of B1 and optionally B2 and/or B3. If component B consists of B1 and B2, the proportion of B1 in component B is preferably at least 20% by weight, more preferably at least 40% by weight. If component B consists of B1 and B3, the proportion of B1 in component B is preferably at least 40% by weight, more preferably at least 45% by weight. Both component B1 and components B2 and B3 do not contain any epoxy groups.

### Component B1

Component B1 comprises rubber-containing graft polymers, prepared by an emulsion polymerization process, of

B1.1) 5% to 95% by weight, preferably 10% to 70% by weight, more preferably 20% to 60% by weight, based on component B1, of a mixture of

B1.1.1) 65% to 85% by weight, preferably 70% to 80% by weight, based on B1.1, of at least one monomer selected from the group of the vinylaromatics (for example styrene, α-methylstyrene), ring-substituted vinylaromatics (for example p-methylstyrene, p-chlorostyrene) and (C1-C8)-alkyl methacrylates (for example methyl methacrylate, ethyl methacrylate) and

B1.1.2) 15% to 35% by weight, preferably 20% to 30% by weight, based on B1.1, of at least one monomer selected from the group of the vinyl cyanides (for example unsaturated nitriles such as acrylonitrile and methacrylonitrile), (C1-C8)-alkyl (meth)acrylates (for example methyl methacrylate, n-butyl acrylate, tert-butyl acrylate) and derivatives (for example anhydrides and imides) of unsaturated carboxylic acids (for example maleic anhydride and N-phenylmaleimide), onto

B1.2) 95% to 5% by weight, preferably 90% to 30% by weight, more preferably 80% to 40% by weight, based on component B1, of at least one elastomeric acrylate rubber graft base. The graft base preferably has a glass transition temperature <0° C., further preferably <−20° C., more preferably <−40° C.

Unless expressly stated otherwise in the present application, the glass transition temperature is determined for all components by differential scanning calorimetry (DSC) according to DIN EN 61006 (1994 version) at a heating rate of 10 K/min with determination of Tg as the midpoint temperature (tangent method).

The graft particles in component B1 preferably have a median particle size (D50) of 0.05 to 5 μm, preferably of 0.1 to 1.0 μm, more preferably of 0.2 to 0.5 μm.

The median particle size D50 is the diameter above and below which 50% by weight of the particles respectively lie. Unless expressly stated otherwise in the present application, it is determined by means of ultracentrifuge measurement (W. Scholtan, H. Lange, Kolloid, Z. and Z. Polymere 250 (1972), 782-1796).

Preferred monomers B1.1.1 are selected from at least one of the monomers styrene, α-methylstyrene and methyl methacrylate; preferred monomers B1.1.2 are selected from at least one of the monomers acrylonitrile, maleic anhydride and methyl methacrylate. Particularly preferred monomers are B1.1.1 styrene and B1.1.2 methyl methacrylate.

Elastomeric acrylate rubber graft bases B1.2 suitable for the graft polymers B1 are preferably polymers of alkyl acrylates, optionally with up to 40% by weight, based on B1.2, of other polymerizable, ethylenically unsaturated monomers. The preferred polymerizable acrylic esters include C₁ to C₈-alkyl esters, for example methyl, ethyl, butyl, n-octyl and 2-ethylhexyl esters; haloalkyl esters, preferably halo-C₁-C₈-alkyl esters, such as chloroethyl acrylate, and also mixtures of these monomers.

Monomers having more than one polymerizable double bond can be copolymerized for crosslinking purposes. Preferred examples of crosslinking monomers are esters of unsaturated monocarboxylic acids having 3 to 8 carbon atoms and unsaturated monohydric alcohols having 3 to 12 carbon atoms, or of saturated polyols having 2 to 4 OH groups and 2 to 20 carbon atoms, such as ethylene glycol dimethacrylate, allyl methacrylate; polyunsaturated heterocyclic compounds, such as trivinyl and triallyl cyanurate; polyfunctional vinyl compounds, such as di- and trivinylbenzenes; but also triallyl phosphate and diallyl phthalate. Preferred crosslinking monomers are allyl methacrylate, ethylene glycol dimethacrylate, diallyl phthalate and heterocyclic compounds which have at least three ethylenically unsaturated groups. Particularly preferred crosslinking monomers are the cyclic monomers triallyl cyanurate, triallyl isocyanurate, triacryloylhexahydro-s-triazine, triallylbenzenes. The amount of the crosslinked monomers is preferably 0.02% to 5%, especially 0.05% to 2%, by weight, based on the graft base B1.2. In the case of cyclic crosslinking monomers having at least three ethylenically unsaturated groups, it is advantageous to limit the amount to below 1% by weight of the graft base B1.2.

The gel content of the graft polymers is at least 40% by weight, preferably at least 60% by weight, more preferably at least 75% by weight (measured in acetone).

The gel content of the graft polymers, unless otherwise stated in the present invention, is determined at 25° C. as the insoluble fraction in acetone as the solvent (M. Hoffmann, H. Kromer, R. Kuhn, Polymeranalytik I and II [Polymer Analysis I and II], Georg Thieme-Verlag, Stuttgart 1977).

The graft polymers B1 are generally prepared by free-radical polymerization.

Particularly preferred polymers B1 are, for example, those polymers prepared by emulsion polymerization as described, for example, in Ullmann, Enzyklopädie der Technischen Chemie [Ullmann's Encyclopedia of Industrial Chemistry], vol. 19 (1980), p. 280 et seq.

On conclusion of the polymerization reaction, the graft polymers are precipitated out of the aqueous phase, followed by an optional wash with water. The last workup step is a drying step.

The graft polymers B1 comprise additives and/or processing auxiliaries optionally present for preparation processes, for example emulsifiers, precipitants, stabilizers and reaction initiators which are not completely removed in the above-described workup. These may be Brønsted-basic or Brønsted-acidic in nature.

As a result of the preparation, graft polymer B1 generally also contains free copolymer of B1.1.1 and B1.1.2, i.e. copolymer not chemically bonded to the rubber base, which is notable in that it can be dissolved in suitable solvents (e.g. acetone).

Preferably, component B1 contains a free copolymer of B1.1.1 and B1.1.2 which has a weight-average molecular weight (Mw), determined by gel permeation chromatography with polystyrene as standard, of preferably 30 000 to 150 000 g/mol, more preferably 40 000 to 120 000 g/mol.

### Component B2

Component B2 of the compositions according to the invention may optionally comprise graft polymers prepared by a bulk, solution or suspension polymerization process. A preferred embodiment in this case comprises graft polymers of

B2.1) 5% to 95% by weight, preferably 80% to 93% by weight, more preferably 85% to 92% by weight, most preferably 87% to 93% by weight, based on component B2, of a mixture of

B2.1.1) 65% to 85% by weight, preferably 70% to 80% by weight, based on the mixture B2.1, of at least one monomer selected from the group of the vinylaromatics (for example styrene, α-methylstyrene), ring-substituted vinylaromatics (for example p-methylstyrene, p-chlorostyrene) and (C1-C8)-alkyl methacrylates (for example methyl methacrylate, ethyl methacrylate) and

B2.1.2) 15% to 35% by weight, preferably 20% to 30% by weight, based on the mixture B2.1, of at least one monomer selected from the group of the vinyl cyanides (for example unsaturated nitriles such as acrylonitrile and methacrylonitrile), (C1-C8)-alkyl (meth)acrylates (for example methyl methacrylate, n-butyl acrylate, tert-butyl acrylate) and derivatives (for example anhydrides and imides) of unsaturated carboxylic acids (for example maleic anhydride and N-phenylmaleimide), onto

B2.2) 95% to 5% by weight, preferably 20% to 7% by weight, particularly preferably 15% to 8% by weight, very particularly preferably 13% to 7% by weight, based on component B2, of at least one graft base.

The graft base preferably has a glass transition temperature <0° C., preferably <−20° C., particularly preferably <−60° C.

The graft particles in component B2 preferably have a median particle size (D50) of 0.1 to 10 μm, preferably of 0.2 to 2 μm, more preferably of 0.3 to 1.0 μm, most preferably of 0.3 to 0.6 μm.

Preferred monomers B2.1.1 are selected from at least one of the monomers styrene, α-methylstyrene and methyl methacrylate; preferred monomers B2.1.2 are selected from at least one of the monomers acrylonitrile, maleic anhydride and methyl methacrylate.

Particularly preferred monomers are B2.1.1 styrene and B2.1.2 acrylonitrile.

Graft bases B2.2 suitable for the graft polymers B2 are, for example, diene rubbers, diene-vinyl block copolymer rubbers, EP(D)M rubbers, i.e. those based on ethylene/propylene and optionally diene, acrylate rubbers, polyurethane rubbers, silicone rubbers, chloroprene rubbers and ethylene/vinyl acetate rubbers, and also mixtures of such rubbers or silicone-acrylate composite rubbers in which the silicone and acrylate components are chemically joined to one another (for example by grafting).

Preferred graft bases B2.2 are diene rubbers (for example based on butadiene or isoprene), diene-vinyl block copolymer rubbers (for example based on butadiene and styrene blocks), copolymers of diene rubbers with further copolymerizable monomers (for example according to B2.1.1 and B2.1.2) and mixtures of the aforementioned rubber types. Particularly preferred graft bases B2.2 are styrene-butadiene block copolymer rubbers and mixtures of styrene-butadiene block copolymer rubbers with pure polybutadiene rubber.

The gel content of the graft polymers B2 is preferably 10% to 35% by weight, more preferably 15% to 30% by weight, most preferably 17% to 23% by weight (measured in acetone).

Particularly preferred polymers B2 are, for example, ABS polymers prepared by free-radical polymerization, which, in a preferred embodiment, contain up to 10% by weight, more preferably up to 5% by weight, most preferably 2% to 5% by weight, based in each case on the graft polymer B2, of n-butyl acrylate.

The graft polymer B2 generally comprises, as a result of the preparation, free copolymer, i.e. copolymer not chemically bound to the rubber base, of B2.1.1 and B2.1.2, which is notable in that it can be dissolved in suitable solvents (e.g. acetone).

Preferably, component B2 contains free copolymer of B2.1.1 and B2.1.2 which has a weight-average molecular weight (Mw), determined by gel permeation chromatography with polystyrene as standard, of preferably 50 000 to 200 000 g/mol, more preferably of 70 000 to 150 000 g/mol, more preferably of 80 000 to 120 000 g/mol.

### Component B3

The composition may optionally comprise, as a further component B3, (co)polymers of at least one monomer from the group of the vinylaromatics, vinyl cyanides (unsaturated nitriles), (C1 to C8)-alkyl (meth)acrylates, unsaturated carboxylic acids and derivatives (such as anhydrides and imides) of unsaturated carboxylic acids.

Especially suitable as component B3 are (co)polymers of

B3.1 50% to 99% by weight, preferably 65% to 85% by weight, more preferably 70% to 80% by weight, based on the (co)polymer B3, of at least one monomer selected from the group of the vinylaromatics (for example styrene, α-methylstyrene), ring-substituted vinylaromatics (for example p-methylstyrene, p-chlorostyrene) and (C1-C8)-alkyl (meth)acrylates (for example methyl methacrylate, n-butyl acrylate, tert-butyl acrylate) and

B3.2 1% to 50% by weight, preferably 15% to 35% by weight, more preferably 20% to 30% by weight, based on the (co)polymer B3, of at least one monomer selected from the group of the vinyl cyanides (for example unsaturated nitriles such as acrylonitrile and methacrylonitrile), (C1-C8)-alkyl (meth)acrylates (for example methyl methacrylate, n-butyl acrylate, tert-butyl acrylate), unsaturated carboxylic acids and derivatives of unsaturated carboxylic acids (for example maleic anhydride and N-phenylmaleimide).

These (co)polymers B3 are resinous, thermoplastic and rubber-free. Particular preference is given to the copolymer of B3.1 styrene and B3.2 acrylonitrile.

(Co)polymers B3 of this kind are known and can be prepared by free-radical polymerization, especially by emulsion, suspension, solution or bulk polymerization.

The (co)polymers B3 have a weight-average molecular weight (Mw), determined by gel permeation chromatography with polystyrene as standard, of preferably 50 000 to 250 000 g/mol, more preferably of 70 000 to 200 000 g/mol, more preferably of 80 000 to 170 000 g/mol.

In a preferred embodiment of the composition according to the invention, component B contains 20% to 80% by weight, preferably 30% to 70% by weight, of component B1, based in each case on component B. Further preferably, component B contains 20% to 80% by weight of component B1 and 20% to 80% by weight of B2, preferably 30% to 50% by weight of component B1 and 50% to 70% by weight of component B2, based in each case on component B.

The preferred moulding compounds according to the invention feature an optimized combination of mechanical properties, good flow characteristics, flame retardancy, particularly at relatively low wall thicknesses, and thermal stability.

In an alternative preferred embodiment of the composition according to the invention, component B contains 40% to 98% by weight of component B1 and 2% to 60% by weight of component B3, preferably 45% to 95% by weight of component B1 and 5% to 55% by weight of component B3, based in each case on component B.

The preferred moulding compounds according to the invention feature an optimized combination of mechanical properties, flame retardancy and thermal stability under defined storage conditions (temperature and air humidity).

### Component C

The composition comprises, as component C, at least one polymer containing structural units derived from styrene and structural units derived from a vinyl monomer containing epoxy groups.

In the context of the present application, an epoxy group is understood to mean the following structural unit:

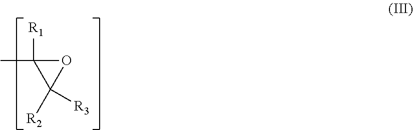

where R1, R2 and R3 are independently hydrogen or methyl. Preferably, at least two of the R1, R2 and R3 radicals are hydrogen; more preferably, all R1, R2 and R3 radicals are hydrogen.

Such vinyl monomers containing epoxy groups to be used for preparation of the component C are, for example, glycidyl acrylate, glycidyl methacrylate, glycidyl ethacrylate, glycidyl itaconate, allyl glycidyl ether, vinyl glycidyl ether, vinylbenzyl glycidyl ether or propenyl glycidyl ether. Glycidyl methacrylate is especially preferred.

In a preferred embodiment, component C comprises a polymer prepared by copolymerization of styrene and at least one styrene-copolymerizable vinyl monomer containing epoxy groups.

In a preferred embodiment, in the preparation of these polymers of component C, as well as styrene and the vinyl monomer containing epoxy groups, at least one further vinyl monomer free of epoxy groups which is copolymerizable with these monomers is used. These further vinyl monomers are selected from the group consisting of vinylaromatics (for example a-methylstyrene), ring-substituted vinylaromatics (for example p-methylstyrene, p-chlorostyrene), (C1-C8)-alkyl (meth)acrylates (for example methyl methacrylate, n-butyl acrylate, tert-butyl acrylate), vinyl cyanides (for example acrylonitrile and methacrylonitrile), unsaturated carboxylic acids (for example maleic acid and N-phenylmaleic acid) and derivatives of unsaturated carboxylic acids (for example maleic anhydride and N-phenylmaleimide).

Especially preferably, the further copolymerizable vinyl monomer used is acrylonitrile.

In a further preferred embodiment, component C comprises at least one polymer containing structural units derived from styrene, acrylonitrile and glycidyl methacrylate, and in a particularly preferred embodiment a polymer consisting of structural units derived from styrene, acrylonitrile and glycidyl methacrylate.

If, aside from structural units derived from styrene and derived from the vinyl monomer containing epoxy groups, structural units derived from a further vinyl monomer free of epoxy groups, as described above, are additionally present in component C, the weight ratio between the structural units derived from styrene and the structural units derived from the further vinyl monomer is in the range from 99:1 to 50:50, preferably in the range from 85:15 to 60:40.

In a further embodiment, component C contains structural units derived from styrene, acrylonitrile and glycidyl methacrylate, where the weight ratio of the styrene-derived structural units to acrylonitrile-derived structural units is especially 99:1 to 50:50, preferably 85:15 to 60:40.

In a preferred embodiment, component C comprises a polymer prepared by copolymerization from styrene, acrylonitrile and glycidyl methacrylate, where the weight ratio of styrene to acrylonitrile is 99:1 to 50:50, preferably 85:15 to 60:40.

The preparation of the polymers of component C from styrene and at least one styrene-copolymerizable vinyl monomer containing epoxy groups is preferably effected by free-radically initiated polymerization, for example by the known method of solution polymerization in organic hydrocarbons. Preference is given here to observing such conditions that hydrolysis of the epoxy groups is at least largely avoided. Suitable and preferred conditions for this purpose are, for example, low contents of polar solvents such as water, alcohol, acids or bases, and working in solvents from the group of the organic hydrocarbons that are inert toward epoxy groups, for example toluene, ethylbenzene, xylene, high-boiling aliphatics, esters or ethers.

An alternative preparation process is the likewise known method of thermally or free-radically initiated, preferably continuous bulk polymerization at temperatures of preferably 40 to 150° C., especially preferably 80 to 130° C., and with optionally only partial monomer conversion, such that the polymer obtained occurs as a solution in the monomer system.

Component C used may also be a block or graft polymer containing structural units derived from styrene and at least one vinyl monomer containing epoxy groups. Block or graft polymers of this kind are prepared, for example, by free-radically initiated polymerization of styrene and optionally further copolymerizable vinyl monomers in the presence of a polymer selected from the group consisting of polycarbonate, polyester, polyestercarbonate, polyolefin, polyacrylate and polymethacrylate.

In a preferred embodiment, block or graft polymers of this kind that are used here are prepared by free-radically initiated polymerization of styrene, a vinyl monomer containing epoxy groups and optionally further copolymerizable vinyl monomers free of epoxy groups in the presence of a polymer selected from the group consisting of polycarbonate, polyester, polyestercarbonate, polyolefin, polyacrylate and polymethacrylate. These polymers may likewise contain epoxy groups, and these in the case of the polyolefins, polyacrylates and polymethacrylates are preferably obtained by copolymerization with vinyl monomers containing epoxy groups.

Vinyl monomers containing epoxy groups and further copolymerizable vinyl monomers free of epoxy groups that are used in block or graft polymers of this kind are the abovementioned monomers.

In a particularly preferred embodiment, a block or graft polymer prepared by free-radically initiated polymerization of styrene, glycidyl methacrylate and acrylonitrile in the presence of a polycarbonate, where styrene and acrylonitrile are used in a weight ratio of 85:15 to 60:40, is used.

Block or graft polymers of this kind are obtained, for example, by swelling or dissolving the abovementioned polymer selected from the group consisting of polycarbonate, polyester, polyestercarbonate, polyolefin, polyacrylate and polymethacrylate in the monomer mixture of styrene and optionally styrene-copolymerizable vinyl monomers, optionally and preferably including vinyl monomer containing epoxy groups, for which purpose it is optionally also possible to use a preferably nonaqueous cosolvent, and reacting it with an organic peroxide as initiator for a free-radical polymerization by increasing the temperature, followed by melt compounding.

In another embodiment, it is possible to use as component C a block or graft polymer prepared by reaction of a polymer containing structural units derived from styrene and from a vinyl monomer containing epoxy groups with a polymer containing OH groups, selected from the group consisting of polycarbonate, polyester and polyestercarbonate.

In the preparation of the block or graft polymers, it may be the case that not all polymer chains selected from the group consisting of polycarbonate, polyester, polyestercarbonate, polyolefin, polyacrylate and polymethacrylate form block or graft polymers with styrene and the optional further vinyl monomers.

Component C in these cases is also understood to mean those polymer mixtures which are obtained by the preparation methods described and in which homopolymers are also present, selected from polycarbonate, polyester, polyestercarbonate, polyolefin, polyacrylate and polymethacrylate and the styrene (co)polymers obtained from styrene and the optional further styrene-copolymerizable vinyl monomers.

Component C may also be a mixture of two or more of the components described above.

Component C has a weight ratio of structural elements that derive from styrene to structural elements that derive from epoxy-containing vinyl monomer of 100:1 to 1:1, preferably of 10:1 to 1:1, further preferably of 5:1 to 1:1, most preferably of 3:1 to 1:1.

Component C has an epoxy content measured according to ASTM D 1652-11 (2011 version) in dichloromethane of 0.1% to 5% by weight, preferably 0.3% to 3% by weight, more preferably 1% to 3% by weight.

Commercially available graft or block polymers which can be used as component C are, for example, Modiper™ CL430-G, Modiper™ A 4100 and Modiper™ A 4400 (each NOF Corporation, Japan). Preference is given to using Modiper™ CL430-G.

### Component D

Phosphorus-containing flame retardants D in the context of the invention are selected from the groups of the mono- and oligomeric phosphoric and phosphonic esters, phosphonate amines and phosphazenes, and it is also possible to use mixtures of a plurality of components selected from one group or various groups among these as flame retardants.

Mono- and oligomeric phosphoric or phosphonic esters in the context of this invention are compounds of the general formula (IV)

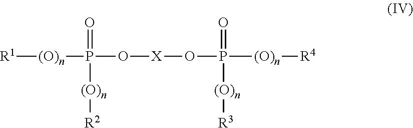

in which

R¹, R², R³ and R⁴ are independently an in each case optionally halogenated C₁ to C₈-alkyl radical, or an in each case optionally alkyl-substituted C₅ to C₆-cycloalkyl, C₆ to C₂₀-aryl or C₇ to C₁₂-aralkyl radical,

n is independently 0 or 1,

q is an integer from 1 to 30, and

X is a polycyclic aromatic radical which has 12 to 30 carbon atoms and is optionally substituted by halogen and/or alkyl groups.

Preferably, R¹, R², R³ and R⁴ are independently C1- to C4-alkyl, phenyl, naphthyl or phenyl-C1-C4-alkyl. The aromatic R¹, R², R³ and R⁴ groups may in turn be substituted by halogen and/or alkyl groups, preferably chlorine, bromine and/or C1- to C4-alkyl. Particularly preferred aryl radicals are cresyl, phenyl, xylenyl, propylphenyl or butylphenyl, and the corresponding brominated and chlorinated derivatives thereof.

X in the formula (II) is preferably a polycyclic aromatic radical having 12 to 30 carbon atoms. The latter preferably derives from diphenols.

n in the formula (II) may independently be 0 or 1; n is preferably 1.

q has integer values from 0 to 30, preferably 0 to 20, more preferably 0 to 10, or in the case of mixtures has average values from 0.8 to 5.0, preferably 1.0 to 3.0, further preferably 1.05 to 2.00 and especially preferably 1.08 to 1.60.

X is more preferably

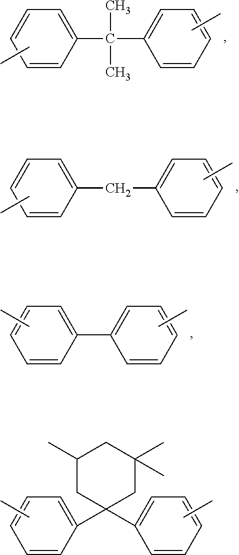

or chlorinated or brominated derivatives of these; in particular, X derives from bisphenol A or from diphenylphenol. More preferably, X derives from bisphenol A.

Phosphorus compounds of the formula (II) are especially tributyl phosphate, triphenyl phosphate, tricresyl phosphate, diphenyl cresyl phosphate, diphenyl octyl phosphate, diphenyl 2-ethylcresyl phosphate, tri(isopropylphenyl) phosphate and bisphenol A-bridged oligophosphate. The use of oligomeric phosphoric esters of the formula (II) which derive from bisphenol A is particularly preferred.

Most preferred as component D is bisphenol A-based oligophosphate of formula (V):

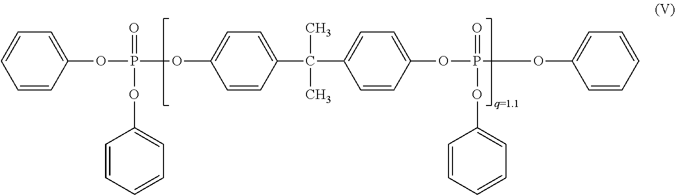

The phosphorus compounds according to component D are known (cf., for example, EP-A 0 363 608, EP-A 0 640 655) or can be prepared in an analogous manner by known methods (e.g. Ullmanns Enzyklopädie der technischen Chemie, vol. 18, p. 301 ff. 1979; Houben-Weyl, Methoden der organischen Chemie [Methods of Organic Chemistry], vol. 12/1, p. 43; Beilstein vol. 6, p. 177).

Other materials that can be used as component D of the invention are mixtures of phosphates with different chemical structure and/or with identical chemical structure and different molecular weight.

Preferably, mixtures having the same structure and different chain length are used, in which case the q value reported is the mean q value. The average q value is determined by using high pressure liquid chromatography (HPLC) at 40° C. in a mixture of acetonitrile and water (50:50) to determine the composition of the phosphorus compound (molecular weight distribution) and using this to calculate the average values for q.

In addition, it is possible to use phosphonate amines and phosphazenes as described in WO 00/00541 and WO 01/18105 as flame retardants.

The flame retardants can be used alone or in any desired mixture with one another, or in a mixture with other flame retardants.

### Component E

The composition may comprise, as component E, one or more further additives preferably selected from the group consisting of antidripping agents, flame retardant synergists, lubricants and demoulding agents (for example pentaerythritol tetrastearate), nucleating agents, antistats, conductivity additives, stabilizers (e.g. hydrolysis, heat ageing and UV stabilizers, and also transesterification inhibitors and acid/base quenchers), flowability promoters, compatibilizers, further impact modifiers other than component B (either with or without core-shell structure), further polymeric constituents (for example functional blend partners), fillers and reinforcers, and dyes and pigments (for example titanium dioxide or iron oxide).

Component E may comprise impact modifiers other than component B. Preference is given to impact modifiers produced by bulk, solution or suspension polymerization, further preferably of the ABS type.

If such impact modifiers prepared by bulk, solution or suspension polymerization are present, the proportion thereof is not more than 20% by weight, preferably not more than 10% by weight, based in each case on the sum total of the impact modifiers prepared by bulk, solution or suspension polymerization and component B.

More preferably, the compositions are free of such impact modifiers prepared by bulk, solution or suspension polymerization.

Further preferably, they do not contain any impact modifiers other than component B.

In a preferred embodiment, the composition contains at least one polymer additive selected from the group consisting of anti-dripping agents and smoke inhibitors.

Antidripping agents used may, for example, be polytetrafluoroethylene (PTFE) or PTFE-containing compositions, an example being a masterbatch of PTFE with styrene- or methyl-methacrylate-containing polymers or copolymers, in the form of powder or of coagulated mixture, for example with component B.

The fluorinated polyolefins used as antidripping agents have high molecular weight and have glass transition temperatures above −30° C., generally above 100° C., fluorine contents that are preferably from 65 to 76% by weight, in particular from 70% to 76% by weight, and d₅₀ median particle diameters from 0.05 to 1000 μm, preferably from 0.08 to 20 μm. The density of the fluorinated polyolefins is generally from 1.2 to 2.3 g/cm³. Preferred fluorinated polyolefins are polytetrafluoroethylene, polyvinylidene fluoride, tetrafluoroethylene/hexafluoropropylene copolymers and ethylene/tetrafluoroethylene copolymers. The fluorinated polyolefins are known (cf. “Vinyl and Related Polymers” by Schildknecht, John Wiley & Sons, Inc., New York, 1962, pp. 484-494; “Fluoropolymers” by Wall, Wiley-Interscience, John Wiley & Sons, Inc., New York, Vol. 13, 1970, pp. 623-654; “Modern Plastics Encyclopedia”, 1970-1971, Vol. 47, No. 10 A, October 1970, McGraw-Hill, Inc., New York, pp. 134 and 774; “Modern Plastics Encyclopedia”, 1975-1976, October 1975, Vol. 52, No. 10 A, McGraw-Hill, Inc., New York, pp. 27, 28 and 472 and U.S. Pat. Nos. 3,671,487, 3,723,373 and 3,838,092).

Suitable fluorinated polyolefins D that can be used in powder form are tetrafluoroethylene polymers with median particle diameters from 100 to 1000 μm and densities from 2.0 g/cm³ to 2.3 g/cm³. Suitable tetrafluoroethylene polymer powders are commercially available products and are supplied by way of example by DuPont with trademark Teflon®.

In a preferred embodiment, the composition comprises at least one polymer additive selected from the group consisting of lubricants and demoulding agents, stabilizers, flowability promoters, compatibilizers, dyes and pigments.

In a preferred embodiment the composition contains at least one polymer additive selected from the group consisting of lubricants/demoulding agents and stabilizers.

In a preferred embodiment the composition contains pentaerythritol tetrastearate as a demoulding agent.

In a preferred embodiment, the composition comprises, as stabilizer, at least one representative selected from the group consisting of sterically hindered phenols, organic phosphites, sulfur-based co-stabilizers and organic and inorganic Brønsted acids.

In a particularly preferred embodiment, the composition comprises, as stabilizer, at least one representative selected from the group consisting of octadecyl 3-(3,5-di-tert-butyl-4-hydroxyphenyl)propionate and tris(2,4-di-tert-butylphenyl) phosphite.

In an especially preferred embodiment, the composition comprises, as stabilizer, a combination of octadecyl 3-(3,5-di-tert-butyl-4-hydroxyphenyl)propionate and tris(2,4-di-tert-butylphenyl) phosphite.

Further preferred compositions comprise pentaerythritol tetrastearate as demoulding agent, and a combination of octadecyl 3-(3,5-di-tert-butyl-4-hydroxyphenyl)propionate and tris(2,4-di-tert-butylphenyl) phosphite as stabilizer.

The composition may comprise, as component E), one or more fillers. Useful fillers for this purpose are in principle all of those that are known to the person skilled in the art for the production of thermoplastic moulding compounds. Useful fillers for this purpose include particulate fillers, fibrous fillers or mixtures of these, preferably of talc, kaolin, wollastonite, glass fibres, further preferably talc, glass fibres or mixtures of these.

### Production of the Moulding Compounds and Moulded Articles

The compositions according to the invention can be used to produce thermoplastic moulding compounds.

The thermoplastic moulding compounds according to the invention can be produced, for example, by mixing the respective constituents of the compositions with one another at temperatures of 200° C. to 320° C., preferably at 240 to 320° C., more preferably at 260 to 300° C. The invention also provides a corresponding process for producing the moulding compounds according to the invention. The mixing can be accomplished in customary aggregates, for example in internal kneaders, extruders and twin-shaft screws. The compositions are melt-compounded or melt-extruded therein to form moulding compounds. For the purposes of this application, this process is generally termed compounding. The term moulding compound therefore means the product that is obtained when the constituents of the composition are compounded in the melt and extruded in the melt.

The individual constituents of the compositions can be mixed in known fashion, either successively or simultaneously, either at about 20° C. (room temperature) or at a higher temperature. It is therefore possible by way of example that some of the constituents are metered into the system by way of the main intake of an extruder and that the remaining constituents are introduced subsequently in the compounding process by way of an ancillary extruder.

The moulding compounds according to the invention can be used to produce moulded articles of any kind. These may be produced by injection moulding, extrusion and blow-moulding processes for example. Another type of processing is the production of moulded articles by thermoforming from prefabricated sheets or films. The moulding compounds according to the invention are particularly suitable for processing by extrusion, blow-moulding and thermoforming methods.

It is also possible to meter the constituents of the compositions directly into an injection moulding machine or into an extrusion unit and to process them to give moulded articles.

The present invention thus further relates to the use of a composition according to the invention or of a moulding compound according to the invention for production of moulded articles, and additionally also a moulded article obtainable from a composition according to the invention formed from a moulding compound according to the invention.

Examples of such moulded articles that can be produced from the compositions and moulding compounds according to the invention are films, profiles, housing parts of any type, for example for domestic appliances such as juice presses, coffee machines, mixers; for office machinery such as monitors, flatscreens, notebooks, printers, copiers; sheets, pipes, electrical installation ducts, windows, doors and other profiles for the construction sector (internal fitout and external applications), and also electrical and electronic components such as switches, plugs and sockets, and component parts for commercial vehicles, in particular for the automobile sector. The compositions and moulding compounds according to the invention are also suitable for production of the following moulded articles or moulded parts: internal fitout parts for rail vehicles, ships, aircraft, buses and other motor vehicles, bodywork components for motor vehicles, housings of electrical equipment containing small transformers, housings for equipment for the processing and transmission of information, housings and facings for medical equipment, massage equipment and housings therefor, toy vehicles for children, sheetlike wall elements, housings for safety equipment, thermally insulated transport containers, moulded parts for sanitation and bath equipment, protective grilles for ventilation openings and housings for garden equipment.

The invention especially relates to the following embodiments:

In a first embodiment, the invention relates to a composition for production of a thermoplastic moulding compound, wherein the composition comprises or consists of at least the following constituents:
A) 50.0% to 95.0% by weight of at least one polymer selected from the group consisting of aromatic polycarbonate, aromatic polyestercarbonate and aromatic polyester,
B) 1.0% to 35.0% by weight of at least one polymer free of epoxy groups, consisting of
   B1) a rubber-modified graft polymer having an elastomeric acrylate rubber graft base,
   B2) optionally a rubber-modified graft polymer based on vinylaromatics, ring-substituted vinylaromatics and/or (C1-C8)-alkyl methacrylates and having a different graft base from component B1), and
   B3) optionally a rubber-free vinyl (co)polymer,
C) 0.1% to 10.0% by weight of a polymer containing structural elements that derive from styrene and an epoxy-containing vinyl monomer,
D) 1.0% to 20.0% by weight of phosphorus-containing flame retardant, and
E) 0.1% to 20.0% by weight of additives,
where component C has a weight ratio of structural elements that derive from styrene to those that derive from epoxy-containing vinyl monomers of 100:1 to 1:1.

In a second embodiment, the invention relates to a composition according to embodiment 1, characterized in that component C comprises structural units derived from at least one further vinyl monomer free of epoxy groups which is copolymerizable with styrene.

In a third embodiment, the invention relates to a composition according to embodiment 1 or 2, characterized in that the weight ratio of the structural units derived from styrene to those derived from the vinyl monomers free of epoxy groups which are copolymerizable with styrene in component C is in the range from 85:15 to 60:40.

In a fourth embodiment, the invention relates to a composition according to any of the above embodiments, characterized in that component C comprises structural units derived from acrylonitrile.

In a fifth embodiment, the invention relates to a composition according to any of the above embodiments, characterized in that the vinyl monomer containing epoxy groups which is used to produce component C is glycidyl acrylate, glycidyl methacrylate, glycidyl ethacrylate, glycidyl itaconate, allyl glycidyl ether, vinyl glycidyl ether, vinylbenzyl glycidyl ether and/or propenyl glycidyl ether, especially glycidyl methacrylate.

In a sixth embodiment, the invention relates to a composition according to any of the above embodiments, characterized in that component C has an epoxy content measured according to ASTM D 1652-11 in dichloromethane of 0.1% to 5% by weight.

In a seventh embodiment, the invention relates to a composition according to any of the above embodiments, characterized in that the emulsion graft polymer B1) has been prepared by an emulsion polymerization process from

B1.1) 5% to 95% by weight, based on component B1, of a mixture of

B1.1.1) 65% to 85% by weight, based on B1.1, of at least one monomer selected from the group of the vinylaromatics, ring-substituted vinylaromatics and (C1-C8)-alkyl methacrylates and

B1.1.2) 15% to 35% by weight, based on B1.1, of at least one monomer selected from the group of the vinyl cyanides, (C1-C8)-alkyl (meth)acrylates and derivatives of unsaturated carboxylic acids, onto

B1.2) 95% to 5% by weight, based on component B1, of at least one elastomeric acrylate rubber graft base.

In an eighth embodiment, the invention relates to a composition according to any of the above embodiments, characterized in that the rubber-modified graft polymer B2) has been prepared by a bulk, solution or suspension polymerization process, preferably by a bulk polymerization process, from

B2.1) 5% to 95% by weight, based on component B2, of a mixture of

B2.1.1) 65% to 85% by weight, based on the mixture B2.1, of at least one monomer selected from the group of the vinylaromatics, ring-substituted vinylaromatics and (C1-C8)-alkyl methacrylates and

B2.1.2) 15% to 35% by weight, based on the mixture B2.1, of at least one monomer selected from the group of the vinyl cyanides, (C1-C8)-alkyl (meth)acrylates and derivatives of unsaturated carboxylic acids, onto

B2.2) 95% to 5% by weight, based on component B2, of at least one graft base.

In a ninth embodiment, the invention relates to a composition according to any of the above embodiments, characterized in that the rubber-free vinyl (co)polymer B3) has been prepared from

B3.1 50% to 99% by weight, based on the (co)polymer B3, of at least one monomer selected from the group of the vinylaromatics, ring-substituted vinylaromatics and (C1-C8)-alkyl (meth)acrylates and

B3.2 1% to 50% by weight, based on the (co)polymer B3, of at least one monomer selected from the group of the vinyl cyanides, (C1-C8)-alkyl (meth)acrylates, unsaturated carboxylic acids and derivatives of unsaturated carboxylic acids.

In a tenth embodiment, the invention relates to a composition according to any of the above embodiments, characterized in that component D is at least one phosphorus-containing flame retardant of the general formula (IV)

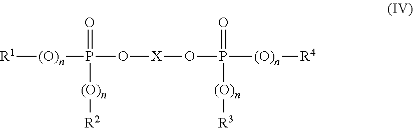

in which

R¹, R², R³ and R⁴ are independently an in each case optionally halogenated C₁ to C₈-alkyl radical, or an in each case optionally alkyl-substituted C₅ to C₆-cycloalkyl, C₆ to C₂₀-aryl or C₇ to C₁₂-aralkyl radical,

n is independently 0 or 1,

q is an integer from 1 to 30, and

X is a polycyclic aromatic radical which has 12 to 30 carbon atoms and is optionally substituted by halogen and/or alkyl groups.

In an eleventh embodiment, the invention relates to a composition according to embodiment 10, characterized in that component D is a compound of the following formula (V):

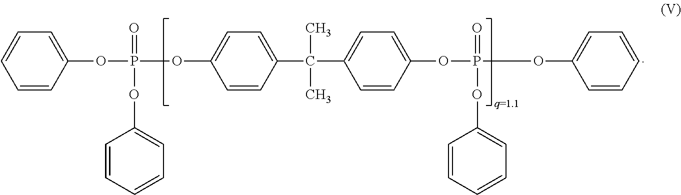

In a twelfth embodiment, the invention relates to a composition according to any of the above embodiments, characterized in that component A has phenolic OH groups and the stoichiometric ratio of the epoxy groups of component C) to the phenolic OH groups of component A is at least 1:1, especially at least 1.1:1, preferably at least 1.2:1.

In a thirteenth embodiment, the invention relates to a composition according to embodiment 12, characterized in that component A has a proportion by weight of phenolic OH groups of 50 to 2000 ppm, preferably 80 to 1000 ppm, more preferably 100 to 700 ppm.

In a fourteenth embodiment, the invention relates to a composition according to any of the above embodiments, characterized in that component B contains 20% to 80% by weight, preferably 30% to 70% by weight, of component B1, based in each case on component B.

In a fifteenth embodiment, the invention relates to a composition according to any of the above embodiments, characterized in that component B contains 20% to 80% by weight of component B1 and 20% to 80% by weight of B2, preferably 30% to 50% by weight of component B1 and 50% to 70% by weight of component B2, based in each case on component B.

In a sixteenth embodiment, the invention relates to a composition according to any of embodiments 1 to 13, characterized in that component B contains 40% to 98% by weight of component B1 and 2% to 60% by weight of component B3, preferably 45% to 95% by weight of component B1 and 5% to 55% by weight of component B3, based in each case on component B.

In a seventeenth embodiment, the invention relates to a composition according to any of embodiments 1 to 15, characterized in that the composition comprises or consists of the following constituents:
A) 51.0% to 85.0% by weight, especially 52.0% to 75.0% by weight, most preferably 55.0% to 72.0% by weight, of aromatic polycarbonate and/or aromatic polyestercarbonate,
B) 2.0% to 25.0% by weight, especially 3.0% to 15.0% by weight, most preferably 5.0% to 14.0% by weight, of polymer free of epoxy groups, consisting of 20% to 80% by weight, especially 30% to 50% by weight, of the emulsion graft polymer B1) prepared by an emulsion polymerization process from
   B1.1) 10% to 70% by weight, preferably 20% to 60% by weight, based on component B 1, of a mixture of
      B1.1.1) 70% to 80% by weight, based on B1.1, of at least one monomer selected from the group of the vinylaromatics, ring-substituted vinylaromatics and (C1-C8)-alkyl methacrylates and
      B1.1.2) 20% to 30% by weight, based on B1.1, of at least one monomer selected from the group of the vinyl cyanides, (C1-C8)-alkyl (meth)acrylates and derivatives of unsaturated carboxylic acids, onto
   B1.2) 90% to 30% by weight, based on component B1, of at least one elastomeric acrylate rubber graft base selected from polymers of alkyl acrylates, optionally with up to 40% by weight, based on B1.2, of other polymerizable, ethylenically unsaturated monomers, where the acrylic esters are preferably selected from C₁ to C₈-alkyl esters, especially methyl, ethyl, butyl, n-octyl and 2-ethylhexyl esters, haloalkyl esters, especially halo-C₁-C₈-alkyl esters, and mixtures of these, and
20% to 80% by weight, especially 50% to 70% by weight, of the bulk, solution or suspension graft polymer B2) prepared by a bulk, solution or suspension polymerization process from
   B2.1) 80% to 93% by weight, especially 85% to 92% by weight, based on component B2, of a mixture of
      B2.1.1) 70% to 80% by weight, based on the mixture B2.1, of at least one monomer selected from the group of the vinylaromatics, ring-substituted vinylaromatics and (C1-C8)-alkyl methacrylates and
      B2.1.2) 20% to 30% by weight, based on the mixture B2.1, of at least one monomer selected from the group of the vinyl cyanides, (C1-C8)-alkyl (meth)acrylates and derivatives of unsaturated carboxylic acids, onto
   B2.2) 20% to 7% by weight, especially 15% to 8% by weight, based on component B2, of at least one graft base,
C) 0.3% to 8.0% by weight, especially 0.5% to 6.0% by weight, most preferably 3.0% to 6.0% by weight, of the epoxy-vinyl polymer comprising or consisting of structural units that derive from styrene and from a vinyl monomer containing epoxy groups,
D) 2.0% to 18.0% by weight, especially 3.0% to 16.0% by weight, most preferably 5.0% to 15.0% by weight, of phosphorus-containing flame retardant, and
E) 0.2% to 18.0% by weight, especially 0.3% to 16.0% by weight, most preferably 0.4% to 10.0% by weight, of additives,
   where the amounts of components A to E and the composition of components B1, B2 and B3 are independent of one another.

In an eighteenth embodiment, the invention relates to a composition according to any of embodiments 1 to 13 and 16, characterized in that the composition comprises or consists of the following constituents:
A) 51.0% to 85.0% by weight, especially 52.0% to 75.0% by weight, of aromatic polycarbonate and/or aromatic polyestercarbonate,
B) 2.0% to 25.0% by weight, especially 3.0% to 15.0% by weight, of polymer free of epoxy groups, consisting of
40% to 98% by weight, especially 45% to 95% by weight, of the emulsion graft polymer B1) prepared by an emulsion polymerization process from
   B1.1) 10% to 70% by weight, preferably 20% to 60% by weight, based on component B1, of a mixture of
      B1.1.1) 70% to 80% by weight, based on B1.1, of at least one monomer selected from the group of the vinylaromatics, ring-substituted vinylaromatics and (C1-C8)-alkyl methacrylates and
      B1.1.2) 20% to 30% by weight, based on B1.1, of at least one monomer selected from the group of the vinyl cyanides, (C1-C8)-alkyl onto
   B1.2) 90% to 30% by weight, based on component B1, of at least one elastomeric acrylate rubber graft base selected from polymers of alkyl acrylates, optionally with up to 40% by weight, based on B1.2, of other polymerizable, ethylenically unsaturated monomers, where the acrylic esters are preferably selected from C₁ to C₈-alkyl esters, especially methyl, ethyl, butyl, n-octyl and 2-ethylhexyl esters, haloalkyl esters, especially halo-C₁-C₈-alkyl esters, and mixtures of these, and
2% to 60% by weight, especially 5% to 55% by weight, of the rubber-free vinyl (co)polymer B3 prepared from
   B3.1 65% to 85% by weight, especially 70% to 80% by weight, based on the (co)polymer B3, of at least one monomer selected from the group of the vinylaromatics, ring-substituted vinylaromatics and (C1-C8)-alkyl (meth)acrylates and
   B3.2 15% to 35% by weight, especially 20% to 30% by weight, based on the (co)polymer B3, of at least one monomer selected from the group of the vinyl cyanides, (C1-C8)-alkyl (meth)acrylates, unsaturated carboxylic acids and derivatives of unsaturated carboxylic acids,
C) 0.3% to 8.0% by weight, especially 0.5% to 6.0% by weight, of the epoxy-vinyl polymer comprising or consisting of structural units that derive from styrene and from a vinyl monomer containing epoxy groups,
D) 2.0% to 18.0% by weight, especially 3.0% to 16.0% by weight, of phosphorus-containing flame retardant, and
E) 0.2% to 18.0% by weight, especially 0.3% to 16.0% by weight, of additives,
   where the amounts of components A to E and the composition of components B1, B2 and B3 are independent of one another.

In a nineteenth embodiment, the invention relates to a composition according to any of embodiments 1 to 13 and 16, characterized in that the composition comprises or consists of the following constituents:
A) 58.0% to 85.0% by weight of aromatic polycarbonate and/or aromatic polyestercarbonate,
B) 5.0% to 20.0% by weight of polymer free of epoxy groups, consisting of 40% to 98% by weight, especially 45% to 95% by weight, of the emulsion graft polymer B1) prepared by an emulsion polymerization process from
   B1.1) 10% to 70% by weight, preferably 20% to 60% by weight, based on component B1, of a mixture of
      B1.1.1) 70% to 80% by weight, based on B1.1, of at least one monomer selected from the group of the vinylaromatics, ring-substituted vinylaromatics and (C1-C8)-alkyl methacrylates and
      B1.1.2) 20% to 30% by weight, based on B1.1, of at least one monomer selected from the group of the vinyl cyanides, (C1-C8)-alkyl (meth)acrylates and derivatives of unsaturated carboxylic acids, onto
   B1.2) 90% to 30% by weight, based on component B1, of at least one elastomeric acrylate rubber graft base selected from polymers of alkyl acrylates, optionally with up to 40% by weight, based on B1.2, of other polymerizable, ethylenically unsaturated monomers, where the acrylic esters are preferably selected from C₁ to C₈-alkyl esters, especially methyl, ethyl, butyl, n-octyl and 2-ethylhexyl esters, haloalkyl esters, especially halo-C₁-C₈-alkyl esters, and mixtures of these, and
2% to 60% by weight, especially 5% to 55% by weight, of the rubber-free vinyl (co)polymer B3 prepared from
   B3.1 65% to 85% by weight, especially 70% to 80% by weight, based on the (co)polymer B3, of at least one monomer selected from the group of the vinylaromatics, ring-substituted vinylaromatics and (C1-C8)-alkyl (meth)acrylates and
   B3.2 15% to 35% by weight, especially 20% to 30% by weight, based on the (co)polymer B3, of at least one monomer selected from the group of the vinyl cyanides, (C1-C8)-alkyl (meth)acrylates, unsaturated carboxylic acids and derivatives of unsaturated carboxylic acids,
C) 3.0% to 6.0% by weight of the epoxy-vinyl polymer comprising or consisting of structural units that derive from styrene and from a vinyl monomer containing epoxy groups,
D) 2.0% to 18.0% by weight of phosphorus-containing flame retardant, and
E) 0.4% to 10.0% by weight of additives,
   where the amounts of components A to E and the composition of components B1 and B3 are independent of one another.

In a twentieth embodiment, the invention relates to a process for producing a moulding compound, characterized in that the constituents of a composition according to any of embodiments 1 to 19 are mixed with one another at a temperature of 200 to 320° C., especially at 240 to 320° C., preferably at 260 to 300° C.

In a twenty-first embodiment, the invention relates to a moulding compound obtained or obtainable by a process according to embodiment 20.

In a twenty-second embodiment, the invention relates to the use of a composition according to any of embodiments 1 to 19 or of a moulding compound according to embodiment 21 for production of moulded articles.

In a twenty-third embodiment, the invention relates to a moulded article obtainable from a composition according to any of embodiments 1 to 19 or from a moulding compound according to embodiment 21.

The invention is elucidated in detail hereinafter by examples.

### EXAMPLES

### Component A1

Linear polycarbonate based on bisphenol A having a weight-average molecular weight Mw of 28 500 g/mol (determined by GPC in methylene chloride with polycarbonate based on bisphenol A as standard) and a proportion by weight of phenolic OH groups of 120 ppm.

### Component A2

Linear polycarbonate based on bisphenol A having a weight-average molecular weight Mw of 26 500 g/mol (determined by GPC in methylene chloride with polycarbonate based on bisphenol A as standard) and a proportion by weight of phenolic OH groups of 140 ppm.

### Component B-1

Graft polymer of 40 parts by weight of methyl methacrylate onto 60 parts by weight of particulate crosslinked poly-n-butyl acrylate rubber (median particle diameter d50=0.50 μm), prepared by emulsion polymerization.

### Component B-2

n-Butyl acrylate-modified graft polymer of the ABS type, prepared by a bulk polymerization process, having an A:B:S ratio of 21:10:65% by weight and an n-butyl acrylate content of 4% by weight. The d₅₀ of the graft particle diameters determined by ultracentrifugation is 0.5 μm. The parent graft base of the graft polymer is a styrene-butadiene block copolymer rubber (SBR). The gel content of the graft polymer measured in acetone is 20% by weight. The weight-average molecular weight M_{w}, measured by GPC with polystyrene as standard in dimethylformamide at 20° C., of the free n-butyl acrylate-modified SAN, i.e. not chemically bound to the rubber or included in the rubber particles in acetone-insoluble form, is 110 kg/mol.

### Component B-3

SAN copolymer with 23% by weight acrylonitrile content and weight-average molecular weight about 130 000 g/mol (determined by GPC in tetrahydrofuran, using polystyrene as standard).

### Component C

Modiper™ CL430-G (NOF Corporation, Japan): polymer containing blocks of polycarbonate and blocks of glycidyl methacrylate-styrene-acrylonitrile terpolymer, which has been obtained by free-radical graft polymerization, initiated by a peroxide, of 30% by weight of a monomer mixture of styrene, acrylonitrile and glycidyl methacrylate in a ratio of 15:6:9% by weight in the presence of 70% by weight of linear polycarbonate based on bisphenol A. The epoxy content of component C measured according to ASTM D 1652-11 in dichloromethane is 2.4% by weight.

### Component D

Bisphenol-A-based oligophosphate

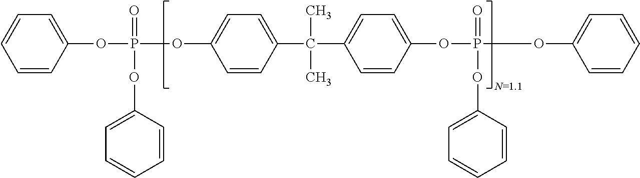

### Component E-1

Cycolac INP449: polytetrafluoroethylene (PTFE) preparation from Sabic composed of 50% by weight of PTFE present in an SAN copolymer matrix.

### Component E-2

Pentaerythritol tetrastearate as demoulding agent

### Component E-3

Irganox B 900 (mixture of 80% Irgafos™ 168 (tris(2,4-di-tert-butylphenyl) phosphite) and 20% Irganox™ 1076 (2,6-di-tert-butyl-4-(octadecanoxycarbonylethyl)phenol); BASF (Ludwigshafen, Germany)

### Component E-4

Pural 200, aluminium oxide hydroxide, average particle size about 50 nm (manufacturer: Condea Hamburg)

### Production and Testing of the Moulding Compounds According to the Invention

The components were mixed in a Werner & Pfleiderer ZSK-25 twin-screw extruder at a melt temperature of 260° C. The moulded articles were produced at a melt temperature of 260° C. and a mould temperature of 80° C. in an Arburg 270 E injection moulding machine. MVR is determined in accordance with ISO 1133 (2012 version) at 240° C., using 5 kg ram loading. Table 1 indicates this value as “MVR value of starting sample”.

The change in MVR during storage of the granulate for 5 days at 95° C. and 100% relative humidity serves as measure of hydrolysis resistance.

Impact resistance (weld line strength) is determined on test specimens measuring 80 mm×10 mm×4 mm at 23° C. in accordance with ISO 179/1eU (2010 version).

Melt viscosity is determined according to ISO 11443 (2014 version) at a temperature of 260° C. and a shear rate of 1000 s⁻¹.

Tensile strain at break is determined at room temperature in accordance with ISO 527 (1996 version).

Flame retardancy is assessed on strips measuring 127×12.7×1.5 mm in accordance with UL94V.

Resistance to environmental stress cracking (ESC) in toluene/isopropanol (60/40 parts by volume) at room temperature serves as measure of chemicals resistance. A test specimen measuring 80 mm×10 mm×4 mm injection-moulded at melt temperature 260° C. is subjected to 2.4% external outer fibre strain by means of a clamping template and completely immersed in the liquid, and the time required for fracture failure induced by environmental stress cracking is determined. The test method is based on ISO 22088 (2006 version).

The content of free bisphenol A monomer was determined by means of high-performance liquid chromatography (HPLC) with a diode array (DAD) detector on the pellets produced by means of a twin-screw extruder. For this purpose, the pellets were first dissolved in dichloromethane and then the polycarbonate was reprecipitated with acetone/methanol. The precipitated polycarbonate and all components of the compositions that are insoluble in the reprecipitant were filtered off, and the filtrates were then concentrated almost to dryness on a rotary evaporator. The residues were analysed by means of HPLC-DAD at room temperature (gradient: acetonitrile/water; stationary phase C-18).

TABLE 1
Moulding compounds and properties thereof

| [parts by | 1 | | | | | | 7 | | | | 11 | | | |
|---|---|---|---|---|---|---|---|---|---|---|---|---|---|---|
| weight] | (comp.) | 2 | 3 | 4 | 5 | 6 | (comp.) | 8 | 9 | 10 | (comp.) | 12 | 13 | 14 |
| Components | | | | | | | | | | | | | | |
| A1 | 71.00 | 70.65 | 70.30 | 69.60 | 68.90 | 66.80 | | | | | | | | |
| A2 | | | | | | | 86.20 | 85.50 | 84.10 | 82.00 | 63.70 | 63.00 | 61.60 | 59.50 |
| B-1 | 5.40 | 5.40 | 5.40 | 5.40 | 5.40 | 5.40 | 5.50 | 5.50 | 5.50 | 5.50 | 10.00 | 10.00 | 10.00 | 10.00 |
| B-2 | 8.60 | 8.45 | 8.30 | 8.00 | 7.70 | 6.80 | — | — | — | — | — | — | — | — |
| B-3 | — | — | — | — | — | — | 2.00 | 1.70 | 1.10 | 0.20 | 10.00 | 9.70 | 9.10 | 8.20 |
| C | — | 0.50 | 1.00 | 2.00 | 3.00 | 6.00 | — | 1.00 | 3.00 | 6.00 | — | 1.00 | 3.00 | 6.00 |
| D | 12.70 | 12.70 | 12.70 | 12.70 | 12.70 | 12.70 | 5.00 | 5.00 | 5.00 | 5.00 | 15.00 | 15.00 | 15.00 | 15.00 |
| E-1 | 1.00 | 1.00 | 1.00 | 1.00 | 1.00 | 1.00 | 0.80 | 0.80 | 0.80 | 0.80 | 0.80 | 0.80 | 0.80 | 0.80 |
| E-2 | 0.40 | 0.40 | 0.40 | 0.40 | 0.40 | 0.40 | 0.40 | 0.40 | 0.40 | 0.40 | 0.40 | 0.40 | 0.40 | 0.40 |
| E-3 | 0.10 | 0.10 | 0.10 | 0.10 | 0.10 | 0.10 | 0.10 | 0.10 | 0.10 | 0.10 | 0.10 | 0.10 | 0.10 | 0.10 |
| E-4 | 0.80 | 0.80 | 0.80 | 0.80 | 0.80 | 0.80 | — | — | — | — | — | — | — | — |
| Properties | | | | | | | | | | | | | | |
| Tensile | 62.5 | 62.9 | 63.0 | 63.1 | 63.4 | 64.2 | 61.3 | 61.8 | 63.3 | 64.2 | 63.1 | 63.9 | 64.4 | 64.8 |
| strength | | | | | | | | | | | | | | |
| [N/mm²] | | | | | | | | | | | | | | |
| Tensile strain | 93.6 | 101.8 | 104.1 | 113.1 | 117.6 | 119.6 | 87.4 | 92.5 | 93.7 | 95.6 | 59.3 | 71.7 | 86.6 | 95.3 |
| at break [%] | | | | | | | | | | | | | | |
| Max. puncture | 4171 | 4189 | 4195 | 4207 | 4230 | 4285 | 4076 | 4105 | 4144 | 4189 | 3978 | 4021 | 4076 | 4106 |
| force [N] | | | | | | | | | | | | | | |
| UL94V assess- | V0 | V0 | V0 | V0 | V0 | V0 | V0 | V0 | V0 | V0 | V0 | V0 | V0 | V0 |
| ment at 1.5 mm | | | | | | | | | | | | | | |
| Total AFT [s] | 43 | 26 | 19 | 16 | 13 | 10 | 39 | 32 | 26 | 20 | 38 | 32 | 27 | 22 |
| (after storage | | | | | | | | | | | | | | |
| at 70° C. | | | | | | | | | | | | | | |
| for 7 days) | | | | | | | | | | | | | | |
| UL94V assess- | V1 | V0 | V0 | V0 | V0 | V0 | V1 | V0 | V0 | V0 | V1 | V0 | V0 | V0 |
| ment at 1.2 mm | | | | | | | | | | | | | | |
| Total AFT [s] | 51 | 41 | 34 | 27 | 25 | 20 | 59 | 46 | 39 | 31 | 75 | 53 | 40 | 32 |
| (after storage | | | | | | | | | | | | | | |
| at 70° C. | | | | | | | | | | | | | | |
| for 7 days) | | | | | | | | | | | | | | |
| Melt Viscosity | 187 | 198 | 205 | 213 | 221 | 235 | 336 | 351 | 379 | 414 | 165 | 187 | 205 | 231 |
| 260° C./1000 | | | | | | | | | | | | | | |
| s−1 [Pas] | | | | | | | | | | | | | | |
| MVR after | 29.8 | 25.6 | 25.0 | 22.4 | 20.9 | 19.9 | 23.8 | 21.1 | 17.9 | 14.2 | 29.5 | 26.7 | 23.8 | 19.5 |
| storage | | | | | | | | | | | | | | |
| (5 days) | | | | | | | | | | | | | | |
| [cm³/10 min] | | | | | | | | | | | | | | |
| MVR after | 28.5 | 25.6 | 25.1 | 23.5 | 22.1 | 20.6 | 13.1 | 12.8 | 12.2 | 11.6 | 25.8 | 24.5 | 23.8 | 21.9 |
| storage | | | | | | | | | | | | | | |
| (15 minutes/ | | | | | | | | | | | | | | |
| 300° C.) | | | | | | | | | | | | | | |
| [cm³/10 min] | | | | | | | | | | | | | | |
| Residual | 21 | 19 | 17 | 15 | 13 | 10 | 25 | 21 | 16 | 12 | 43 | 37 | 31 | 24 |
| BPA content | | | | | | | | | | | | | | |
| [ppm] | | | | | | | | | | | | | | |

The examples from Table 1 show that only the compositions comprising component C achieve a good combination of good mechanical properties (elongation at break, tensile strength, high force absorbance in the puncture test), improved flame retardancy with shortened afterflame times and, in particular, good melt stability after thermal storage and hydrolytic stress and, in addition, after processing, give a lower content of phenols formed as a result of polycarbonate degradation phenomena, especially of bisphenol A. In the comparative tests without component C, the melt flow index after thermal storage and hydrolytic stress is higher, as are the residual BPA contents.

A particularly favourable profile of properties is achieved when the proportion of component C is in the range from 3.0% to 6.0% by weight. The properties mentioned are improved to the greatest degree and the increase in the melt viscosity is still within an acceptable range.

1. A thermoplastic moulding composition, wherein the composition comprises:
A) 50.0% to 95.0% by weight of at least one polymer selected from the group consisting of aromatic polycarbonate, aromatic polyestercarbonate and aromatic polyester;
B) 1.0% to 35.0% by weight of at least one polymer free of epoxy groups, consisting of
B1) a rubber-modified graft polymer having an elastomeric acrylate rubber graft base,
B2) optionally a rubber-modified graft polymer based on vinylaromatics, ring-substituted vinylaromatics and/or (C1-C8)-alkyl methacrylates and having a different graft base from component B1), and
B3) optionally a rubber-free vinyl (co)polymer;
C) 0.1% to 10.0% by weight of a polymer comprising structural elements that derive from styrene and an epoxy-containing vinyl monomer;
D) 1.0% to 20.0% by weight of phosphorus-containing flame retardant; and
E) 0.1 % to 20.0% by weight of additives,
wherein component C has a weight ratio of structural elements that derive from styrene to those that derive from epoxy-containing vinyl monomers of 100:1 to 1:1.

2. The composition of claim 1, wherein component C is a block polymer or graft polymer.

3. The composition of claim 1, wherein component C comprises structural units derived from at least one further vinyl monomer free of epoxy groups which is copolymerizable with styrene, and wherein the weight ratio of the structural units derived from styrene to those derived from the vinyl monomers free of epoxy groups which are copolymerizable with styrene in component C is in the range from 85:15 to 60:40.

4. The composition of claim 1, wherein component C comprises structural units derived from acrylonitrile.

5. The composition of claim 1, wherein the vinyl monomer containing epoxy groups which is used to produce component C is selected from the group consisting of glycidyl acrylate, glycidyl methacrylate, glycidyl ethacrylate, glycidyl itaconate, allyl glycidyl ether, vinyl glycidyl ether, vinylbenzyl glycidyl ether and propenyl glycidyl ether.

6. The composition of claim 1, wherein the emulsion graft polymer B1) is a reaction product of components comprising:
B1.1) 5% to 95% by weight, based on component B1, of a mixture of
B1.1.1) 65% to 85% by weight, based on B1.1, of at least one monomer selected from the group of the vinylaromatics, ring-substituted vinylaromatics and (C1-C8)-alkyl methacrylates and
B1.1.2) 15% to 35% by weight, based on B1.1, of at least one monomer selected from the group of the vinyl cyanides, (C1-C8)-alkyl (meth)acrylates and derivatives of unsaturated carboxylic acids, and
B1.2) 95% to 5% by weight, based on component B1, of at least one elastomeric acrylate rubber graft base.

7. The composition of claim 1, wherein component D is at least one phosphorus-containing flame retardant of the general formula (IV) 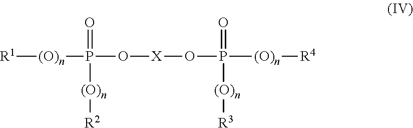
in which
R¹, R², R³ and R⁴ are independently an in each case optionally halogenated C₁ to C₈-alkyl radical, or an in each case optionally alkyl-substituted C₅ to C₆-cycloalkyl, C₆ to C₂₀-aryl or C₇ to C₁₂-aralkyl radical,
n is independently 0 or 1,
q is an integer from 1 to 30, and
X is a polycyclic aromatic radical which has 12 to 30 carbon atoms and is optionally substituted by halogen and/or alkyl groups

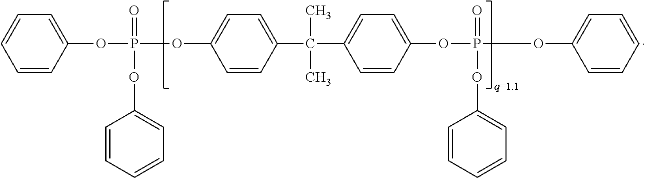

8. The composition of claim 1, wherein component A has phenolic OH groups and the stoichiometric ratio of the epoxy groups of component C to the phenolic OH groups of component A is at least 1:1.

9. The composition of claim 1, wherein component B comprises 20% to 80% by weight of component B1 and 20% to 80% by weight of B2, based on component B.

10. The composition of claim 1, wherein component B comprises 40% to 98% by weight of component B1 and 2% to 60% by weight of component B3, based on component B.

11. The composition of claim 1, comprising:
A) 52.0% to 75.0% by weight, of aromatic polycarbonate and/or aromatic polyestercarbonate,
B) 3.0% to 15.0% by weight, of polymer free of epoxy groups, consisting of 30% to 50% by weight, of the emulsion graft polymer B1) is a reaction product of components comprising:
B1.1) 20% to 60% by weight, based on component B1, of a mixture of
B1.1.1) 70% to 80% by weight, based on B1.1, of at least one monomer selected from the group of the vinylaromatics, ring-substituted vinylaromatics and (C1-C8)-alkyl methacrylates and
B1.1.2) 20% to 30% by weight, based on B1.1, of at least one monomer selected from the group of the vinyl cyanides, (C1-C8)-alkyl (meth)acrylates and derivatives of unsaturated carboxylic acids, and
B1.2) 90% to 30% by weight, based on component B1, of at least one elastomeric acrylate rubber graft base selected from polymers of alkyl acrylates, optionally with up to 40% by weight, based on B1.2, of other polymerizable, ethylenically unsaturated monomers, where the acrylic esters are selected from C₁ to C₈-alkyl esters, especially methyl, ethyl, butyl, n-octyl and 2-ethylhexyl esters, haloalkyl esters, especially halo-C₁-C₈-alkyl esters, and mixtures of these, and
50% to 70% by weight, of the bulk, solution or suspension graft polymer B2), a reaction product of components comprising:
B2.1) 80% to 93% by weight, based on component B2, of a mixture of
B2.1.1) 70% to 80% by weight, based on the mixture B2.1, of at least one monomer selected from the group of the vinylaromatics, ring-substituted vinylaromatics and (C1-C8)-alkyl methacrylates and
B2.1.2) 20% to 30% by weight, based on the mixture B2.1, of at least one monomer selected from the group of the vinyl cyanides, (C1-C8)-alkyl (meth)acrylates and derivatives of unsaturated carboxylic acids, onto
B2.2) 20% to 7% by weight, based on component B2, of at least one graft base,
C) 0.3% to 8.0% by weight of the epoxy-vinyl polymer comprising structural units that derive from styrene and from a vinyl monomer containing epoxy groups,
D) 2.0% to 18.0% by weight of phosphorus-containing flame retardant, and
E) 0.2% to 18.0% by weight of additives,
where the amounts of components A to E and the composition of components B1, B2 and B3 are independent of one another.

12. The composition of claim 11, comprising:
55.0% to 72.0% by weight of component A,
5.0% to 14.0% by weight of component B,
3.0% to 6.0% by weight of component C,
5.0% to 15.0% by weight of component D,
0.4% to 10.0% by weight of component E.

13. The composition of claim 1, comprising:
A) 52.0% to 75.0% by weight, of aromatic polycarbonate and/or aromatic polyestercarbonate,
B) 3.0% to 15.0% by weight, of polymer free of epoxy groups, consisting of 45% to 95% by weight, of the emulsion graft polymer B1), a reaction product of components comprising:
B1.1) 20% to 60% by weight, based on component B1, of a mixture of
B1.1.1) 70% to 80% by weight, based on B1.1, of at least one monomer selected from the group of the vinylaromatics, ring-substituted vinylaromatics and (C1-C8)-alkyl methacrylates and
B1.1.2) 20% to 30% by weight, based on B1.1, of at least one monomer selected from the group of the vinyl cyanides, (C1-C8)-alkyl (meth)acrylates and derivatives of unsaturated carboxylic acids, and
B1.2) 90% to 30% by weight, based on component B1, of at least one elastomeric acrylate rubber graft base selected from polymers of alkyl acrylates, optionally with up to 40% by weight, based on B1.2, of other polymerizable, ethylenically unsaturated monomers, where the acrylic esters are preferably selected from C₁ to C₈-alkyl esters, especially methyl, ethyl, butyl, n-octyl and 2-ethylhexyl esters, haloalkyl esters, especially halo-C₁-C₈-alkyl esters, and mixtures of these, and
5% to 55% by weight, of the rubber-free vinyl (co)polymer B3 prepared from
B3.1 70% to 80% by weight, based on the (co)polymer B3, of at least one monomer selected from the group of the vinylaromatics, ring-substituted vinylaromatics and (C1-C8)-alkyl (meth)acrylates and
B3.2 20% to 30% by weight, based on the (co)polymer B3, of at least one monomer selected from the group of the vinyl cyanides, (C1-C8)-alkyl (meth)acrylates, unsaturated carboxylic acids and derivatives of unsaturated carboxylic acids,
C) 0.5% to 6.0% by weight, of the epoxy-vinyl polymer comprising structural units that derive from styrene and from a vinyl monomer containing epoxy groups,
D) 0.3% to 16.0% by weight, of phosphorus-containing flame retardant, and
E) 0.3% to 16.0% by weight, of additives,
where the amounts of components A to E and the composition of components B1, B2 and B3 are independent of one another.

14. The composition of claim 1, comprising:
A) 58.0% to 85.0% by weight of aromatic polycarbonate and/or aromatic polyestercarbonate,
B) 5.0% to 20.0% by weight of polymer free of epoxy groups, consisting of 45% to 95% by weight, of the emulsion graft polymer B1), a reaction product of components comprising:
B1.1) 20% to 60% by weight, based on component B1, of a mixture of
B1.1.1) 70% to 80% by weight, based on B1.1, of at least one monomer selected from the group of the vinylaromatics, ring-substituted vinylaromatics and (C1-C8)-alkyl methacrylates and
B1.1.2) 20% to 30% by weight, based on B1.1, of at least one monomer selected from the group of the vinyl cyanides, (C1-C8)-alkyl (meth)acrylates and derivatives of unsaturated carboxylic acids, and
B1.2) 90% to 30% by weight, based on component B1, of at least one elastomeric acrylate rubber graft base selected from polymers of alkyl acrylates, optionally with up to 40% by weight, based on B1.2, of other polymerizable, ethylenically unsaturated monomers, where the acrylic esters are preferably selected from C₁ to C₈-alkyl esters, especially methyl, ethyl, butyl, n-octyl and 2-ethylhexyl esters, haloalkyl esters, especially halo-C₁-C₈-alkyl esters, and mixtures of these, and
5% to 55% by weight, of the rubber-free vinyl (co)polymer B3, a reaction product of components comprising:
B3.1 70% to 80% by weight, based on the (co)polymer B3, of at least one monomer selected from the group of the vinylaromatics, ring-substituted vinylaromatics and (C1-C8)-alkyl (meth)acrylates and
B3.2 20% to 30% by weight, based on the (co)polymer B3, of at least one monomer selected from the group of the vinyl cyanides, (C1-C8)-alkyl (meth)acrylates, unsaturated carboxylic acids and derivatives of unsaturated carboxylic acids,
C) 3.0% to 6.0% by weight of the epoxy-vinyl polymer comprising structural units that derive from styrene and from a vinyl monomer containing epoxy groups,
D) 2.0% to 18.0% by weight of phosphorus-containing flame retardant, and
E) 0.4% to 10.0% by weight of additives,
where the amounts of components A to E and the composition of components B1 and B3 are independent of one another.

15-17. (canceled)

18. A moulded article comprising the composition of claim 1.

19. The composition of claim 1, wherein component C has an epoxy content measured according to ASTM D 1652-11 in dichloromethane of 0.1% to 5% by weight.

20. The composition of claim 1, wherein the rubber-modified graft polymer B2) is a reaction product of components comprising:
B2.1) 5% to 95% by weight, based on component B2, of a mixture of
B2.1.1) 65% to 85% by weight, based on the mixture B2.1, of at least one monomer selected from the group of the vinylaromatics, ring-substituted vinylaromatics and (C1-C8)-alkyl methacrylates and
B2.1.2) 15% to 35% by weight, based on the mixture B2.1, of at least one monomer selected from the group of the vinyl cyanides, (C1-C8)-alkyl (meth)acrylates and derivatives of unsaturated carboxylic acids, and B2.2) 95% to 5% by weight, based on component B2, of at least one graft base.

21. The composition of claim 1, wherein the rubber-free vinyl (co)polymer B3) is a reaction product of components comprising:
B3.1 50% to 99% by weight, based on the (co)polymer B3, of at least one monomer selected from the group of the vinylaromatics, ring-substituted vinylaromatics and (C1-C8)-alkyl (meth)acrylates and
B3.2 1% to 50% by weight, based on the (co)polymer B3, of at least one monomer selected from the group of the vinyl cyanides, (C1-C8)-alkyl (meth)acrylates, unsaturated carboxylic acids and derivatives of unsaturated carboxylic acids.

22. The composition of claim 1, wherein component D has the following formula (V):

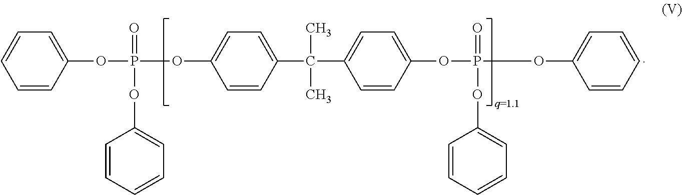

23. The composition of claim 1 wherein component A has a proportion by weight of phenolic OH groups of 50 to 2000 ppm.
